(19) United States
(12) Patent Application Publication
(10) Pub. No.: US 2025/0360476 A1
(43) Pub. Date: Nov. 27, 2025

(54) HAND-OPERATED CONSTRUCTION MIXER, IN PARTICULAR HAND-OPERATED STIRRING MACHINE FOR STIRRING AND/OR MIXING CONSTRUCTION MATERIALS

(71) Applicant: Collomix GmbH, Gaimersheim (DE)

(72) Inventors: Alexander Essing, Ingolstadt (DE); Martin Baumann, Gaimersheim (DE)

(21) Appl. No.: 19/189,571

(22) Filed: Apr. 25, 2025

(30) Foreign Application Priority Data
May 24, 2024 (EP) 24177828.1

(51) Int. Cl. B01F 33/501; B01F 35/221; B01F 35/222; B01F 35/32; B01F 35/33; B01F 35/60

(52) U.S. Cl. CPC B01F 33/5011; B01F 35/221422; B01F 35/22161; B01F 35/222; B01F 35/3204; B01F 35/33; B01F 35/6052; B01F 2215/0481

(57) ABSTRACT

A hand-operated construction mixer, such as a hand-operated stirring machine for stirring and/or mixing construction materials, has a housing and a drive motor accommodated, at least on part, in the housing interior. The drive motor has at least one drive shaft, which is operatively connectable directly or indirectly to a mixing and/or stirring tool. An actuating device is provided, by way of which the drive motor is actuatable. The drive motor, preferably controlled via a control device coupled to the actuating device, is suitable and configured to provide a rotational speed, preferably a load rotational speed, at the drive shaft driving the mixing and/or stirring tool in a range from 200 rpm to 1000 rpm, preferably from 250 rpm to 750 rpm, most preferably from 300 rpm to 650 rpm.

### CROSS-REFERENCE TO RELATED APPLICATION

This application claims the priority, under 35 U.S.C. § 119, of European Patent Application EP 24 177 828.1, filed May 24, 2024; the prior application is herewith incorporated by reference in its entirety.

### FIELD AND BACKGROUND OF THE INVENTION

The invention relates to a hand-operated construction mixer, in particular a hand-operated stirring machine for stirring and/or mixing construction materials.

Hand-operated construction mixers, or mixing machines, that are electrically driven are known for professional stirring and mixing of materials, in particular at construction sites. Materials stirred and mixed in particular include ready-mixed plaster and mortar, filling compounds, paints, adhesives, wallpaper paste, screed, coatings, sealing compounds, and many others.

A hand-operated construction mixer of this type is known from German utility model DE 20 2010 014 783 U1. The mixer comprises a handle element and a housing, wherein a drive motor is accommodated in the housing and the drive motor comprises a drive shaft which is operatively connected to a shaft of a mixing and/or stirring tool. The housing is formed in two parts and comprises an upper housing part which forms a housing cover that is directly connected to the lower housing part by means of several screw connections. The housing cover is supported on a ring element of a crossbar of the handle element, wherein the crossbar or its ring element is connected to the lower housing part by means of several screw connections. The crossbar of the handle element comprises transverse struts projecting on both sides of the housing, which are each provided with handles that are in turn formed by grip shells. An actuating device formed by a hand switch is part of one of the two handles and is connected to the drive motor via a cable connection. Upon actuation of the hand switch, the drive motor is activated, thereby rotationally driving the mixing and stirring tool for the respective mixing task. In practice, the actuating device formed by the hand switch is configured such that the machine runs faster the further the hand switch is pressed. Additionally, such machines may also be equipped with a mechanical gear shift providing two different maximum rotational speeds, namely a first slower gear and, compared thereto, a second faster gear. Very good mixing results can thus already be achieved using such a construction mixer.

### SUMMARY OF THE INVENTION

In contrast, the object underlying the present invention is to provide a hand-operated construction mixer, in particular a hand-operated stirring machine for stirring and/or mixing construction materials, which has a particularly robust structure that is not prone to damage and/or which can be optimally adapted in an individual manner to a wide variety of stirring and/or mixing tasks.

With the above and other objects in view there is provided, in accordance with the invention, a hand-operated construction mixer, comprising:
a housing formed with a housing interior;
a drive motor accommodated, at least in part, in said housing interior, said drive motor having at least one drive shaft to be directly or indirectly operatively connected to a mixing and/or stirring tool;
an actuating device configured for actuating said drive motor;
said drive motor, under control via a control device coupled to said actuating device, being configured to rotate said drive shaft and the mixing and/or stirring tool at a rotational speed in a range from 200 rpm to 1000 rpm, or in a range from 250 rpm to 750 rpm, or in a range from 300 rpm to 650 rpm.

In other words, the objects of the invention are achieved, in accordance with the invention, with a hand-held construction mixer, in particular a hand-operated stirring machine for stirring and/or mixing construction materials, comprising a housing, in the interior of which a drive motor is accommodated at least in part, preferably completely, the drive motor comprising at least one drive shaft which is operatively connectable directly or indirectly to a mixing and/or stirring tool.

Furthermore, an actuating device is provided, by means of which the drive motor is actuable, in particular activatable and optionally deactivatable. The actuating device may, for example, be formed by a spring-preloaded hand switch. It is further advantageous if the actuating device has the function of an ON/OFF switch. This has the advantage that the construction mixer can only be operated when the actuating device is actuated, and the stirring and/or mixing operation can be simply terminated by releasing the actuating device.

According to a particularly preferred embodiment, it is provided that the drive motor, preferably controlled via a control device coupled to the actuating device, is suitable and configured to provide a rotational speed, preferably a load rotational speed, at the drive shaft driving the mixing and/or stirring tool in a range from 200 rpm to 1000 rpm, preferably from 250 rpm to 750 rpm, most preferably from 300 rpm to 650 rpm.

It is preferably provided that the rotational speed is effected by a gearbox or a gear reduction of the drive motor, which provides a motor rotational speed, preferably a load motor rotational speed, at the motor output shaft, preferably at the rotor shaft as the motor output shaft, in a range from 12,000 rpm to 21,000 rpm, preferably from 14,000 rpm to 19,000 rpm, most preferably from 16,000 rpm to 17,000 rpm.

A drive motor configured in such a manner allows a wide range of rotational speeds to be provided at the output or drive shaft, thereby enabling the construction mixer to be used for a variety of mixing applications and materials, such as lower rotational speeds for heavy, viscous materials and higher rotational speeds for lighter, more fluid materials. In particular, this enables a high torque to be provided at low speed, as is required, for example, when mixing heavy materials. Furthermore, the oversizing of the motor results in a high air output of the fan and a high torque, which ensures sufficient performance and cooling in the reduced speed range. The rotational speed is selectable, for example in increments of 50, by means of the optionally present electronics module, which renders a mechanical gear shift with additional components superfluous. This also simplifies the manufacture of the gearbox housing, as no transversely extending gear-shift knob seated in the housing wall needs to be guided and sealed.

This means that such a motor/gearbox combination offers a number of advantages that meet the needs and requirements of the users in many respects and which are summarized once again below:

A first essential advantage of the construction mixer lies in the absence of a need for manual gear shifting. Due to the possibility of electronic gear selection via the electronics module, an external hand-operated gear switch on the construction mixer is no longer necessary. This also results in a further decisive advantage, namely the associated cost savings. The reduction in components and the simplification of assembly processes lead to a significant reduction in manufacturing costs. Finally, the slowly rotating motor contributes to a significant reduction in noise, which makes the working environment considerably more pleasant. Accordingly, it is provided according to a particularly preferred embodiment that the gearbox of the construction mixer is not a gearbox that is externally and/or manually switchable by an operator.

According to a particularly preferred embodiment, it is provided that the gearbox has a gear reduction ratio in the range from 35:1 to 15:1, preferably from 30:1 to 20:1.

In principle, the drive motor could be designed as a pneumatic or hydraulic drive motor. However, according to a particularly preferred embodiment, it is provided that the drive motor is formed by an electric motor comprising a rotor and a stator. Electric motors enable more precise control of speed and torque compared to hydraulic or pneumatic drives. In addition, electric motors are less prone to wear than hydraulic or pneumatic systems, particularly with respect to possible leakages. Electric motors are also often quieter in operation than hydraulic or pneumatic drives, which makes the working environment more pleasant and reduces the risk of noise disturbance.

The housing is preferably formed in one or more parts, more preferably in multiple parts, and comprises an upper housing part which forms a housing cover and is, preferably detachably, connected to a one-part or multi-part lower housing part. All directional indications, such as the terms “top,” “upper,” “bottom,” “lower,” etc., refer, unless explicitly stated otherwise, both in the description and in the claims always to the vertical axis direction of the construction mixer corresponding to its usage position.

Furthermore, the construction mixer preferably comprises a handle unit which comprises or forms at least one handle and is connected to the housing. The term handle generally refers to any configuration that can be grasped by an operator during operation of the construction mixer in order to hold the construction mixer in the desired position during a mixing and/or stirring operation.

The actuating device is preferably coupled to the control device, by means of which the drive motor is electronically controllable upon actuation of the actuating device. Such a control device allows the rotational speed and/or velocity of the drive motor to be precisely adjusted and thereby controlled in a particularly simple manner according to the respective mixing and/or stirring tasks. This also enables the speed or rotational speed of the stirring and/or mixing tool to be precisely adapted to the requirements of the mixing material to be stirred or mixed in each case, which in turn results in improved mixing quality, less dust caused by whirled-up dry material, less spillage from the bucket, and a reduced noise level. A further particular advantage of a control device is that it may also include additional functions, such as safety functions, by means of which the operation of the drive motor can be monitored. The control device thus allows more precise and flexible use while at the same time ensuring efficient operation of the construction mixer.

The control device is, in principle, preferably formed by a control unit as an electronic unit which contains the entire control logic (including any algorithms) and performs the processing of commands. This may be, for example, a microcontroller or a programmable logic controller (PLC), to name only a few examples. The control device may be coupled to sensors and user interfaces (touchscreens, physical switches, etc.), for example, in order to receive signals and commands on the basis of which the control device then controls the operation of the construction mixer based on its control logic by outputting control signals to the drive motor or by controlling the drive motor via a voltage pulsed by phase angle control.

In a simplified embodiment, this can be achieved, for example, in that the actuating device, for example a hand switch as the actuating device, comprises and/or includes a simple control device or control electronics, or in that the control device is arranged directly adjacent to the actuating device, for example with both components arranged on or in a handle. In this case, the control device may be coupled to the actuating device in such a manner that the rotational speed of the construction mixer is adjusted as a function of the actuation path of the actuating device, for example when being pressed by the operator. This means, for example, that the more strongly the actuating device formed, for example, by a hand switch is pressed or depressed, the faster the drive motor or the construction mixer runs.

According to a particularly preferred embodiment, it is provided that the control device is part of an electronics module which is arranged in the housing interior, preferably in the area of the housing cover, and/or, with reference to the usage position of the construction mixer, above the drive motor, and is electrically connected to the drive motor. Such an optional integration of a control device into an electronics module offers the possibility of linking the control device in a very small installation space with possibly further electronic functional units. In particular, the arrangement of an electronics module in the housing interior, preferably in the area of the housing cover, and/or above the drive motor enables a compact design with short connection paths of electrical lines or cables to the components to be supplied with energy. In addition, such electronics modules also allow, in a particularly simple manner, programming of the control device or, if necessary, also configuration of the control device with regard to the setting of different operating modes. For example, sensors may also be integrated into an electronics module in order to monitor various parameters, optionally also to detect faults and perform diagnostics. Moreover, such electronics modules can be easily combined with user interfaces, such as displays, buttons, or touchscreens, which simplify interaction with the construction mixer and enable more intuitive or individualized operation. Thus, the housing and, particularly preferably, the electronics module may comprise a display and/or operating unit by means of which an operating state of the drive motor is displayable and/or an operating mode of the drive motor is enterable. Alternatively, the display and/or operating unit may also be directly integrated into the housing cover. In this embodiment variant, advantageous functional integration results, since the housing cover simultaneously serves in a dual function for the mounting and arrangement of the display and/or operating unit. This also results in a particularly compact construction. Mixed variants are, of course, also possible, i.e. that one part of the components of the display and/or operating unit is arranged on the housing cover and another part of the components of the display and/or operating unit is arranged on the electronics module. In all embodiment variants, the display and/or operating unit is particularly preferably operable and/or accessible via an access area of the housing cover which lies in the direct field of view of a user.

The access area may be formed in different ways, for example by an operating film or a recess in the housing cover, preferably in an upper side of the housing cover, via which the display and/or operating unit is operable and/or accessible. Operating films enable reliable protection against external influences such as dust, moisture, and contamination, but also require increased manufacturing effort, such that, according to a particularly preferred embodiment, it is provided that the access area is formed by a recess in the housing cover, preferably in an upper side of the housing cover. In connection with such a particularly preferred embodiment, the display and/or operating unit is preferably arranged on a visible side of the electronics module, which closes the recess in the mounted state, in particular closes it in a sealed manner, and forms part of the upper side of the housing cover. Even with such an embodiment, reliable protection of the housing interior against external influences such as dust, moisture, and contamination is achieved. This is achieved in particular if the visible side of the electronics module closes the recess in the mounted state in a sealed manner. Also in this case, an operating film may, of course, be provided on the visible side of the electronics module and thus in the area of the display and/or operating unit.

The display and/or operating unit comprises at least one interaction element, preferably at least one physical input button and/or at least one virtual input surface (for example touchscreen). By means of such an interaction element, at least one mixing parameter, preferably the mixing time and/or the rotational speed, is adjustable or specifiable. This solution offers the advantage that the user can conveniently control and monitor the mixing parameters directly from the construction mixer itself, which increases the flexibility and user-friendliness of the construction mixer. Alternatively or additionally, the display and/or operating unit may be signal-transmissively connectable to at least one external interaction element, preferably in connection with an app, by means of which at least one mixing parameter, preferably the mixing time and/or the rotational speed, is adjustable or specifiable. For this purpose, the display and/or operating unit or the control device of the construction mixer coupled to the display and/or operating unit may be equipped with a communication module that enables wireless communication with a corresponding app of the mobile device. This may be done via Bluetooth, WLAN, or another wireless technology. A user can then download a corresponding app onto his mobile device and couple it with the construction mixer. The user can then set the desired mixing parameters, for example the mixing time and rotational speed, via the app. Or the user scans a code on a container in which the mixing material is contained, for example a code on a cement bag, so that the code then specifies the mixing parameters. The display and/or operating unit may also display the set, for example scanned, mixing parameters, so that the user can check whether the settings have been correctly adopted. During the mixing process, the app may also receive data from the construction mixer, for example regarding the current operating states or mixing parameters.

Alternatively or additionally, it is provided according to a further particularly preferred embodiment that the display and/or operating unit comprises at least one display, on which at least one piece of information characterizing the mixing process, preferably the mixing time and/or the rotational speed, is displayable. In the case of exclusively displaying the mixing time with automatic resetting, a physical input button can for example be omitted. The term “characterizing information” encompasses everything that can be shown on a display, regardless of whether it is numerical values, diagrams, graphics, images, or other visual information.

Using the display and/or operating unit, the mixing time in particular can be well displayed and monitored. Thus, according to a particularly preferred embodiment, it is provided that the control device comprises a time counter function, preferably with a pause function, by means of which the mixing time is displayable on the display upon actuation of the actuating device, wherein it is preferably provided that the time counter starts for a predetermined time upon actuation of the construction mixer by means of the actuating device and/or that the time counter comprises a pause function, by means of which, depending on a predetermined pause time, the time counter is either reset to zero if the pause time is exceeded, or continues to run if the pause time is not exceeded. This time counter function makes it possible to record the mixing time during which the construction mixer is in operation and to optionally take pause times into account. For example, upon actuation of the construction mixer, the time counter may start automatically. The time counter either continues running continuously and counts the entire operating time of the construction mixer or stops after a predefined time has elapsed. The optional pause function makes it possible to interrupt the mixing operation. Depending on a previously defined pause time, the time counter may either be reset to zero if the pause time is exceeded or continue running if the pause time is not exceeded. The time settings, including the operating time and the pause time, may either be predefined by the manufacturer or optionally also be adapted by users or operators depending on the requirements of the application. In this case, the control device then allows the time intervals for operation and pauses to be individually defined in order to meet the various work requirements. The time counter function of the construction mixer thus provides an efficient means of monitoring the operating time and the mixing times, managing pauses, and adapting the operation to specific requirements.

According to a further particularly preferred embodiment, it is provided that the actuating device, preferably a hand switch, most preferably a hand switch preloaded into the OFF position, is part of the handle unit, which is wirelessly or wiredly connectable to the control device, preferably to the electronics module and thus to the control device, or is connected thereto. The actuating device, which preferably simultaneously functions as an ON switch, most preferably as an ON/OFF switch, can, when arranged in the area of the handle unit, in particular as will be explained in more detail below, in the area of a handle of the handle unit, be conveniently actuated by the operator by hand, in particular in connection with a preferred two-hand operation of the construction mixer.

According to a further particularly preferred embodiment, it may also be provided that the actuating device is coupled to a power-on locking element which releasably locks the actuating device and which, in order to release the actuation of the actuating device, is activatable, in particular depressible, in addition to the actuating device. Such a power-on locking element thus constitutes an additional safety function, by means of which unintentional actuations of the construction mixer can be avoided.

The handle element preferably further comprises a crossbar formed in one or more parts and/or oriented transversely to the longitudinal extension direction of the housing and functioning as a handle bracket, with a ring element. The ring element surrounds the housing interior at least in sections or in portions in a ring-shaped manner and/or is supported and/or fastened at an opening edge region of the lower housing part forming the housing opening of the lower housing part, preferably detachably fastened by means of at least one fastening element. It is particularly preferably provided that the crossbar additionally comprises or forms the at least one handle. With such a handle element, which comprises a crossbar or handle bracket with a ring element, a defined and functionally reliable support of the handle element on the housing can be achieved, which is particularly advantageous for defined force transmission into the housing. The terms “ring-shaped” and “in sections” used in connection with the ring element are expressly to be understood in a very broad sense and encompass all configurations and/or embodiments in which some type of circumferential support of the handle element on one or more defined regions of the opening edge region of the lower housing part takes place, whether the ring element is ring-closed or has interruptions in the circumferential direction to form segment-like sections. Form configurations deviating from a circular ring shape, such as angular, oval, or the like, are also possible at any time and are encompassed by the term “ring-shaped” and by “ring element.”

At this point, it is also to be noted that the drive motor, in the case of a housing formed in multiple parts with a housing cover, is preferably accommodated essentially completely in the lower housing part.

According to a preferred specific embodiment, it is provided that the crossbar, in particular for a particularly preferred two-hand operation of the construction mixer, comprises or forms two handles which are arranged on opposite transverse bar sides in the transverse direction of the ring element located in a central area between the two handles, preferably centrally or in the middle between the two handles. Such a two-hand operation is the preferred operation of the construction mixer according to the invention, as this enables particularly simple control and management of the stirring and/or mixing process.

For a convenient grip, it is particularly preferred that each handle is connected to the ring element via at least one transverse strut, preferably projecting radially from the ring element, preferably each handle being connected to the ring element via multiple, in particular two, transverse struts projecting from the ring element on each transverse bar side and spaced apart from one another. The latter is preferred in connection with an embodiment in which it is provided that the transverse struts and the handles are formed approximately U-shaped and the handles form or constitute part of the U-base. Connecting the handles via multiple transverse struts enables a particularly stable configuration of the crossbar and also an advantageous distribution of force, so that the loads occurring during the stirring and/or mixing operation can be distributed more evenly.

In particular, for convenient manual operation, it is provided according to a particularly preferred specific embodiment that the actuating device, preferably a hand switch forming the actuating device, is part of the at least one handle or is part of at least one of the handles. According to a further particularly preferred specific embodiment, it is provided that a cable connection, which is formed by at least one electrical line or by a bundle of multiple electrical lines, extends from the actuating device via at least one of the transverse struts of the crossbar, preferably outwardly encapsulated by means of a protective shell that can be arranged on the transverse strut side, to the housing and into the housing interior to a connection element. The connection element may, depending on the embodiment of the construction mixer, be formed by different components, particularly preferably by a connector arranged in the interior of the housing, which combines multiple electrical lines forming, for example, a cable bundle or a cable harness, in a plug element and provides them for connection to a plug connector, in particular for connection to a plug connector of an electronics module. Alternatively, however, the connection element may also be formed by the control device or the electronics module itself, or further alternatively, particularly in a simplified embodiment without an electronics module in the housing interior, by the drive motor, in which case the switch includes a simple control device or control electronics. Such a cable connection is also easy to manufacture and advantageously utilizes the already present transverse strut of the crossbar in a dual function simultaneously for routing the at least one electrical line of the cable connection. The encapsulated cable or line routing also serves to form a second electrical insulation layer, thereby achieving a so-called “protective insulation.” This not only reduces the number of components required but also allows for a compact design that can also be well integrated into the design of the construction mixer overall.

Furthermore, it may alternatively or additionally be provided that the actuating device, preferably a hand switch, is arranged on an underside of the handle with respect to the usage position of the construction mixer, which allows particularly advantageous actuation of the actuating device by means of the index finger and/or middle finger of a hand.

Particularly preferred is also an embodiment in which the handles are ergonomically shaped, for example in such a manner that the handles, in the case of two handles and with respect to the gripping position seen from the user, are angled inward from the outside in the manner of an inverted “V” in order to force the user's hands into an optimal gripping position for two-hand operation. Alternatively or additionally, the handles may also have a dome-like projection in a central area on their inner side facing the housing, which, in top view, merges on both sides with a curved dome region in an arc shape into the associated inner side area of the handle. The dome region of the inner side facing away from the user serves as a convenient thumb rest and is therefore a preferred location at which the actuating device formed, for example, by a hand switch is arranged for convenient thumb operation. The dome region facing the user, on the other hand, is oriented toward the index finger when the handles are gripped and thus also defines an area that automatically indicates the correct gripping position to the operator.

Furthermore, it is preferably provided that the handle comprises a hollow and/or receiving space in which a partial area of the actuating device that is operable and accessible from the outside, in particular a partial area of a hand switch that is operable and accessible from the outside, is mounted and/or received and/or in which a part of the cable connection runs and/or is received. This allows, on the one hand, a particularly advantageous mounting and arrangement of an actuating device, in particular in the form of a hand switch, and, on the other hand, also a shielding of the cable connection associated with the actuating device from the environment.

Furthermore, a power cable for supplying power to the construction mixer may terminate at the at least one handle, preferably at the handle with the actuating device, preferably terminating in a hollow and/or receiving space of the handle, wherein a cable connection with at least one electrical line extends from the power cable via the handle and via at least one of the transverse struts of the crossbar, preferably encapsulated by means of a protective shell that can be arranged on the transverse strut side, preferably the same protective shell as the cable connection of the actuating device, to the housing and into the housing interior to a connection element. The connection element may, depending on the embodiment of the construction mixer, be formed by different components, particularly preferably by a connector arranged in the interior of the housing, which combines multiple electrical lines forming, for example, a cable bundle or a cable harness, in a plug element and provides them for connection to a plug connector, in particular for connection to a plug connector of an electronics module. Alternatively, however, the connection element may also be formed by the control device or the electronics module itself, or further alternatively, particularly in a simplified embodiment without an electronics module in the housing interior, by the drive motor.

It is also preferably provided that the power cable exits the handle on a handle side facing a user, whereby it can be reliably avoided that the power cable possibly winds around the mixing and/or stirring tool.

According to a further particularly preferred embodiment, it is provided that a handle, preferably the handle not comprising the actuating device, comprises at least one interaction element, preferably at least one physical input button, by means of which at least one mixing parameter, preferably the rotational speed of the drive shaft, is adjustable and/or specifiable. In this way, a desired mixing parameter, in particular the rotational speed, can be conveniently set, changed, and/or adjusted by the operator also during operation of the construction mixer, optionally independently of a speed setting possibility via a display and/or operating unit of an electronics module, without the need to do so via a display and/or operating unit arranged in the area of the housing cover, so that the hands can remain on the machine.

In connection with this embodiment, it is particularly preferred that a cable connection with at least one electrical line extends from the at least one interaction element via the handle and via at least one of the transverse struts of the crossbar, preferably encapsulated outwardly by means of a protective shell that can be arranged on the transverse strut side, to the housing and into the housing interior to a connection element. The connection element may, depending on the embodiment of the construction mixer, be formed by different components, particularly preferably by a connector arranged in the interior of the housing, which combines multiple electrical lines forming, for example, a cable bundle or a cable harness in a plug element and provides them for connection to a plug connector, in particular for connection to a plug connector of an electronics module. Alternatively, however, the connection element may also be formed by the control device or the electronics module itself, or further alternatively, particularly in a simplified embodiment without an electronics module in the housing interior, by the drive motor. In this case, the actuating device would then be provided with a phase-angle control.

The at least one interaction element is preferably arranged on an upper side of the handle with respect to the usage position of the construction mixer, in particular in such a manner that actuation by the operator is conveniently possible by means of a thumb.

According to a particularly preferred specific embodiment, two interaction elements are provided in particular, wherein a first interaction element serves to increase the rotational speed and a second interaction element serves to reduce the rotational speed.

Both the crossbar and the handles may, in principle, be manufactured from any suitable material. Particularly preferably, the crossbar, in particular for an overall stable construction and a high-quality optical appearance, is manufactured from a metal, in particular from a steel material. The handles themselves are preferably manufactured from a plastic material. In particular, but not exclusively for this reason, it is advantageous in connection with the handles explained in more detail below, which are formed by grip shells, if the crossbar, that is, the ring element and the transverse struts of the crossbar, is formed flat and strip-like, in particular by a flat steel or a flat metal, although other cross-sectional shapes, for example round or angular cross-sectional shapes, are of course also possible. Such a handle bracket can, for example, be cut out from a metal or steel plate. However, this flat shaping of the crossbar is also advantageous if it is optionally made of another material, for example of a plastic material. In general, therefore, the crossbar has a flat or plate-shaped cross-section.

As already indicated above, it is advantageous for flexible handle design and arrangement that the at least one handle is formed by grip shells which are connected to one another and/or to the transverse struts, preferably in such a manner that, on each transverse bar side, two mutually spaced transverse strut ends of two spaced-apart transverse struts serve to define and/or support the grip shells, which receive the associated transverse strut regions between them, preferably clamp them between each other.

For this purpose, it may be provided, according to a simply manufacturable and also functionally reliable fastening of the grip shells and of the handle, that each of the transverse strut ends of two transverse struts assigned to a handle comprises at least one positioning hole, preferably multiple, in particular two positioning holes spaced apart in the longitudinal extension direction of the transverse strut. Furthermore, in this context, two grip shell-side domes, preferably screw domes with an internal thread, spaced apart in the longitudinal direction of the handle, are arranged on a first grip shell of the handle, which are formed in a pin-like manner and which, in the mounted state of the handle, are each assigned to a positioning hole in the two transverse strut ends, preferably engage in an assigned positioning hole of the two transverse strut ends, and are each further assigned to a grip shell-side dome opening, preferably a through-screw opening, of a second grip shell of the handle. It is furthermore preferably provided that the two grip shells, in the mounted state, rest on and/or bear against the transverse strut ends, preferably receive them between each other and/or clamp them between each other, and are connected to each other by means of at least one fastening element, preferably at least one screw connection. The at least one fastening element, for example at least one screw connection, may be provided spaced from the domes or the dome openings, but is preferably formed for particularly advantageous functional integration by a screw connection with a fastening screw which is screwed through the through-screw opening and the assigned positioning hole into an assigned screw dome. At this point, it is expressly noted that, in all usage cases and embodiments described herein in which components are provided with an internal thread, the internal thread may either already be formed in this component, for example in the screw dome, from the outset, or may only be cut into the component, for example into the screw dome, by screwing in a fastening screw. It is likewise understood that, in all usage cases and embodiments described herein, a fastening screw is generally a screw with a screw head which is supported on the circumferential edge region of the assigned through-screw opening in order to form the screw connection, even if this is not explicitly stated or explained.

According to a further particularly preferred embodiment, it is preferably provided that the first grip shell and/or the second grip shell, preferably both grip shells, is or are supported in the mounted state resting against the assigned transverse strut end. In particular, by means of the latter measure, advantageous load relief for the screw connections is achieved, for example in the case that a force acts on the handles, as may occur, for example, when the construction mixer falls over.

According to a particularly preferred embodiment, it is provided that the at least one handle, preferably both handles in the case of two handles, is held on the handle element, preferably on the at least one transverse strut, in a position- and/or location-adjustable manner, preferably in such a way that the distance of the at least one handle, preferably both handles, to the housing and/or to the ring element is adjustable and variable. Depending on the embodiment, this can be done continuously or in steps. Such a change in the position and location of the at least one handle, preferably both handles, relative to the housing allows particularly simple and functionally reliable adjustment of the grip width of the construction mixer.

According to a particularly preferred specific embodiment relating thereto, it is provided that at least one of the transverse strut ends assigned to a handle comprises multiple, in particular two, positioning holes spaced apart from one another in the longitudinal extension direction of the transverse strut, to which, in the different handle positions, in each case a dome, preferably a screw dome, and a dome opening, preferably a through-screw opening, of the grip shells can be assigned. In this way, the change in the position and location of the at least one handle can be achieved simply by plugging between mutually spaced positioning holes. According to a particularly preferred specific embodiment, it is provided that both transverse strut ends assigned to a handle comprise multiple, in particular two, positioning holes spaced apart from one another in the longitudinal extension direction of the transverse struts, such that the grip shells, for the purpose of changing the position and location, can be assigned to the outermost positioning holes for a maximum grip width or to an inner pair of positioning holes for a reduced grip width. For this purpose, it may be specifically provided that the positioning holes at the transverse strut ends each have a spacing of 10 mm to 50 mm and/or that an identical number of positioning holes is formed at each of the transverse strut ends. In this way, all common grip widths can be adjusted in a simple and functionally reliable manner.

According to a further particularly preferred embodiment, it is provided that the transverse struts project beyond the handles fixed thereto at least in part with a fall-protection overhang, wherein it is preferably provided that the fall-protection overhang is formed by a buffer element that can be arranged on the transverse strut ends, preferably attachable, preferably made of a plastic material, most preferably made of an elastomer material, and/or that the buffer element is clamped between the grip shells in the mounted state. With such a buffer element, effective fall protection is provided, which can also be simply adapted to the different positions or locations of a handle relative to the housing. This is achieved in particular with a specific embodiment in which it is provided that the buffer element is held on the transverse strut ends so as to be displaceable with respect to the longitudinal extension direction of the transverse struts and/or for adaptation to different handle positions, and/or in which it is provided that the buffer element has, on opposite sides facing the grip shells, in each case at least one latching element, preferably at least one latching groove, which interacts with at least one latching counter-element, preferably at least one latching projection, on the grip shells, in particular in such a manner that they engage in one another in a form-fitting and/or contour-matching manner.

According to a further particularly preferred embodiment, the ring element is preferably connected to the lower housing part, preferably with the interposition of a connection and/or insulation ring, which surrounds the housing interior in a ring-shaped manner at least in sections or partially, preferably completely, and/or which is supported and/or fastened on an opening edge region of the lower housing part forming the housing opening of the lower housing part. The terms “ring-shaped” and “in sections” used in connection with the connection and/or insulation ring are expressly to be understood in a very broad sense and include all those configurations and/or embodiments in which some type of peripheral support of the connection and/or insulation ring takes place at one or more defined areas of the opening edge region of the lower housing part, regardless of whether the connection and/or insulation ring is closed in a ring shape or has interruptions in the circumferential direction for the formation of segment-like sections. Shapes deviating from a circular ring shape, for example angular, oval, or the like, are also possible at any time and are encompassed by the term “ring-shaped” and by “ring.” Accordingly, the connection and/or insulation ring may be formed as a continuous ring extending in the circumferential direction or may be formed by multiple ring segments spaced apart from one another in the circumferential direction. The particular advantage of such a connection and/or insulation ring lies, on the one hand, in the fact that it forms an insulation layer, in particular a further insulation layer, in the housing interior, so that electrical protective measures can be reduced, for example, a protective conductor in the cable connections in the housing interior can be omitted. In addition, such a connection and/or insulation ring also significantly increases the structural flexibility of the construction mixer, as it can advantageously be used for fastening a housing cover and/or for supporting and centering an electronics module, as will be explained in more detail below.

For functionally reliable support and bearing of the connection and/or insulation ring, it is provided according to a particularly preferred specific embodiment that the opening edge region of the lower housing part comprises a bearing and receiving surface extending circumferentially at least in sections or partially, on which the connection and/or insulation ring rests. According to a particularly preferred embodiment that can be produced simply in connection with the manufacture of the housing, it is provided that the bearing and receiving surface is formed by ribs formed on the opening edge region and spaced apart from one another in the circumferential direction. These ribs may, if applicable, also be part of an air supply in a particularly advantageous dual function, which is formed, for example, by housing-side ventilation slots formed in the area of these ribs, via which cooling air can flow into the housing interior.

According to a further particularly preferred specific embodiment, it is provided that the bearing and receiving surface is offset downward relative to an outer circumferential opening edge of the opening edge region, preferably offset downward by the thickness or material thickness of the connection and/or insulation ring in such a way that the upper edge of the opening edge lies substantially flush with an upper side of the connection and/or insulation ring and together with it forms a, preferably flat, bearing surface for the ring element of the crossbar. This provides an advantageous flat and gap-free bearing possibility for the ring element of the crossbar, so that it can be securely and reliably connected to or fixed on the opening edge region.

According to a specific embodiment for a particularly advantageous connection of the ring element to the opening edge region, it is provided that the support and receiving surface comprises multiple screw domes with an internal thread, spaced apart from one another in the circumferential direction of the opening edge region, to which through-screw openings on the connection and/or insulation ring and through-screw openings on the ring element are assigned, such that fastening screws for fixing the ring element to the lower housing part can be screwed in from the upper side of the ring element through the through-screw openings of the connection and/or insulation ring and through the through-screw openings of the ring element into the screw domes. According to a further preferred optional embodiment in this regard, it is provided that the screw domes project in a pin-like manner from the support and receiving surface and extend at least into the assigned through-screw openings of the connection and/or insulation ring. In this context, it is further advantageous if the through-screw openings of the connection and/or insulation ring are formed in the manner of pipe stubs and, in the mounted state, with their free end-side end face rest around the respective assigned screw dome on a support area of the support and receiving surface while receiving the respective screw dome within the interior of the through-screw opening. Overall, such a configuration results in particularly reliable and functionally secure centered accommodation and support of the connection and/or insulation ring on the opening edge region of the lower housing part. This also ensures that the connection and/or insulation ring is always mounted in the correct position on the lower housing part. A mounting error is thus reliably prevented.

Furthermore, according to a particularly preferred embodiment, it is provided that the support and receiving surface comprises multiple centering pins spaced apart from one another in the circumferential direction of the opening edge region, to which centering openings are assigned at least on the ring element (for example in the case of a segment-like embodiment of the connection and/or insulation ring), or to which centering openings on the connection and/or insulation ring and centering openings on the ring element are assigned. In this case, it is preferably provided that the centering pins project from the support and receiving surface and (optionally additionally through the centering openings of the connection and/or insulation ring) extend from below in the direction of the assigned centering openings on the ring element or at least partially engage in the assigned centering openings on the ring element. These centering pins may thus, on the one hand, serve the functionally secure positioning of the ring element on the connection and/or insulation ring and, on the other hand, in a dual function, also serve as centering pins for the connection and/or insulation ring itself. A mounting error of both the connection and/or insulation ring and the ring element and thus the crossbar can thus be functionally securely and reliably excluded.

According to a further particularly preferred embodiment, it is furthermore proposed that the housing cover, in the mounted state, rests and/or is supported with a circumferential edge region on the ring element and/or that the housing cover has, on its underside, centering pins assigned to the centering openings of the ring element, which, in the mounted state of the housing cover, partially extend from above into the assigned centering openings on the ring element, preferably in such a manner that the free ends of the housing-cover-side centering pins have a gap spacing to the centering pins on the support and receiving surface side, which also engage in the centering openings. The centering openings on the ring element thus serve a beneficial dual function, namely on the one hand for the positionally correct arrangement of the ring element and thus of the crossbar on the lower housing part, and on the other hand for the positionally correct arrangement of the cover on the ring element or the lower housing part.

As already mentioned above, it is particularly advantageous in connection with the embodiments just described if the ring element, in the mounted state, lies with a, preferably flat, contact surface area in a surface contact connection on the, preferably flat, upper side of the connection and/or insulation ring facing the ring element. This enables gap-free contact and reliable and functionally secure fixation of the crossbar on the housing.

According to a further particularly preferred specific embodiment, it is provided that the housing cover is connected to the connection and/or insulation ring by means of at least one connecting device, preferably releasably connected, most preferably screwed by means of at least one screw connection as connecting device, preferably additionally with a supporting bearing of a circumferential edge region of the housing cover on the ring element. Such a connection or in particular screw connection of the housing cover to the connection and/or insulation ring has the advantage that forces acting on the housing via the housing cover, for example in a drop test, are no longer transmitted directly from the housing cover to the lower housing part but can instead be absorbed and returned by the housing cover alone. As a result, destruction of the lower housing part, which functions as a motor housing, can preferably be avoided. The separation of the housing cover leads to a different introduction and redirection of force, so that the forces acting on the housing can be better managed and distributed. The connection and/or insulation ring thereby serves as a yielding element so that the screw connection of the housing cover does not sustain damage.

For fixing the housing cover to the connection and/or insulation ring, it is preferably provided that the connection and/or insulation ring comprises multiple screw-in elements with internal threads spaced from one another in the circumferential direction, to which cover-side through-screw openings formed on the housing cover, in particular spaced from one another in the circumferential direction, are assigned in such a way that, for establishing a screw connection, a fastening screw can be screwed in from the outside of the cover through the respective through-screw opening into the assigned screw-in element.

According to a particularly preferred embodiment in this context, the screw-in elements may be formed by pin-like screw domes protruding from the connection and/or insulation ring in the direction of the housing cover, wherein it is preferably provided that the screw domes are assigned dome recesses in the ring element, preferably the screw domes engage in or pass through dome recesses in the ring element, most preferably pass through the dome recesses in the ring element in such a way that they protrude beyond the ring element on the side facing the housing cover. The dome recesses may in this case be, for example, recesses formed at the inner edge of the ring opening of the ring element, to name just one example. With such pin-like screw domes as screw-in elements of the connection and/or insulation ring, a particularly preferred load relief of the screws is achieved, especially if the housing cover, according to a further particularly preferred embodiment, preferably a housing cover with a recess, is dome-shaped and comprises a side wall region extending circumferentially, in which the cover-side through-screw openings are formed spaced apart from one another in the circumferential direction. In connection with such an embodiment, it is possible for the cover-side through-screw openings to be formed by pin-like pipe stubs protruding from the underside of the side wall region, which, in the mounted state, are aligned with and directly adjacent to the screw-in elements, preferably adjacent to them with a defined gap spacing or bearing against them.

According to a further particularly preferred embodiment, it is provided that the preferably dome-shaped housing cover, in the mounted state, rests and/or is supported with a circumferential edge region on the ring element, preferably rests and/or is supported in such a way that the housing cover substantially follows the outer circumferential contour of the ring element and/or that the fastening screws used for fixing the ring element to the lower housing part lie inside the housing cover. As a result, an overall large-area housing cover is formed, which is advantageous in connection with an embodiment in which the housing cover is also equipped with a display and/or operating unit. Furthermore, the fastening screws for fixing the ring element can advantageously lie inside the housing cover, so that they are not freely accessible from the outside.

According to a further particularly preferred embodiment, it is provided that the connection and/or insulation ring comprises or forms a retaining device for the control device or the electronics module, on which the control device or the electronics module is supported and/or mounted. As already explained above, the connection and/or insulation ring thereby serves in an additional function advantageously as a retaining device for another component, namely for the electronics module, which is arranged in the housing interior, preferably in the area of the housing cover.

A particularly preferred embodiment provides that the retaining device is formed by multiple retaining elements spaced apart from one another in the circumferential direction of the connection and/or insulation ring, each of which is assigned a counter-retaining element on the electronics module, preferably on the outer circumference of the electronics module and/or on the underside of the electronics module. For example, the retaining elements may be easily formed by retaining rings with a ring opening, each of which is assigned a retaining pin as a counter-retaining element on the electronics module in such a way that, in the mounted state of the electronics module, a retaining pin is received and held in the ring opening of an assigned retaining ring. A kinematic reversal is of course also possible, i.e., an arrangement of retaining rings on the electronics module and an arrangement of retaining pins on the connection and/or insulation ring. With such a specific embodiment, simple mounting and centering of the electronics module in the housing interior is achieved. In particular, in connection with an embodiment in which the electronics module lies in a form-fitting manner against the housing cover with its visible side, in particular with its visible side comprising a display and/or operating unit, there is, although this could theoretically always be the case, no further necessity for securing the electronics module, for example via screw connections or the like, since in such an embodiment, the electronics module is functionally securely held, in particular clamped, between the housing cover on the one hand and the connection and/or insulation ring on the other hand.

An advantageous component integration results if the retaining elements, viewed in the radial direction, directly adjoin the screw-in elements, in particular if the retaining elements are materially unified and integrally formed with the screw-in elements and/or if the retaining elements protrude from the opening edge region into the housing opening of the lower housing part.

For an elastically resilient connection of the electronics module to the connection and/or insulation ring or of the housing cover to the connection and/or insulation ring, depending on the acting forces, it may be provided that the retaining elements and/or the screw-in elements are elastically resiliently connected to the connection and/or insulation ring. This can be achieved, for example, by a simply manufacturable cut-in and/or cut-out in the connection and/or insulation ring, so that the retaining elements and/or the screw-in elements, in particular their functionally integrated component unit, are connected to the connection and/or insulation ring in a regionally free-hanging manner. In connection with forces acting on the housing, this enables advantageous force absorption, which helps to prevent damage in the area of the housing or the electronics module. Such a connection thus also has the specific advantage that it reliably protects the electronics module, for example in a drop test.

The connection and/or insulation ring may preferably be made from any suitable material, in particular from an electrically non-conductive material, preferably from plastic.

In addition, the connection and/or insulation ring may comprise, preferably on its underside facing away from the ring element or in the area of its underside facing away from the ring element, at least one spacer or form at least one spacer in cooperation with at least one spacer wall of the lower housing part, preferably in order to keep electrical lines at a distance from defined components, in particular at a distance from the ring element. Moreover, electrical lines can thereby be bundled in a simple and advantageous way in the wall-near region of the lower housing part and routed to a connection element, for example to a plug connector in the housing interior and/or to the drive motor and/or to the electronics module and/or out of the housing. This creates an advantageous air and creepage distance between the electrical lines and the crossbar of the handle element, which is preferably formed as a metal or steel bracket. Additionally, this also advantageously limits the degree of freedom of the electrical lines and allows for a short cable routing.

According to a further particularly preferred embodiment, the electronics module comprises, preferably on a bottom side facing the drive motor, at least one sensor device coupled to the control device, wherein the drive motor comprises at least one indicator element coupled to the rotor shaft, which rotates with the rotor shaft within the detection range of the sensor device, wherein the sensor device is suitable and configured to detect defined rotational data, in particular the position and/or orientation, of the at least one indicator element and to transmit a corresponding signal to the control device, in particular for determining the rotational speed of the drive motor. With such an arrangement, the control device can precisely control the rotational speed and torque of the drive motor. Furthermore, accurate detection of the position of the indicator element allows the control device to enable automated functions, such as soft starting and stopping of the drive motor or adjusting the mixing speed according to predefined control programs. The term “rotor shaft” is explicitly to be understood in a broad sense within the scope of the present invention concept and is explicitly not intended to be limited only to applications in which the drive motor is formed by an electric motor. Rather, the term “rotor shaft” is expressly intended to represent the term “motor output shaft” or “motor drive shaft” in all those cases in which the drive motor is not formed by an electric motor.

The sensor device may, for example, be formed by a magnetoresistive sensor, preferably by a Hall sensor, wherein the at least one indicator element in this case is preferably formed by a magnetic element, which is preferably formed by a magnet, for example a permanent magnet as magnetic element, or alternatively by a magnetic element manufactured at least in sections from a magnetic material. With such a magnetoresistive sensor, particularly advantageous and reliable speed detection can be achieved.

According to a further particularly preferred embodiment, which is characterized in particular by high reliability and structural compactness, the at least one indicator element is a component of a magnetic ring that is connected to the rotor shaft, preferably to the free end of the rotor shaft facing the electronics module. The magnetic ring comprises a plurality of magnetic elements spaced apart from one another in the circumferential direction, wherein it is preferably provided that the sensor device is arranged eccentrically with respect to the axis of rotation of the magnetic ring and/or that the magnetic elements are received in pockets of the magnetic ring, in particular in a loss-proof manner. The eccentric arrangement reliably ensures in a simple manner that the sensor device is not positioned precisely in the dead zone for detecting the position of the magnetic elements of the magnetic ring.

According to a further particularly preferred embodiment, it may additionally be provided that the magnetic ring is supported and connected to the rotor shaft by means of multiple retaining arms spaced apart from one another in the circumferential direction, preferably supported and connected at the free end of the rotor shaft, wherein it is preferably provided that the retaining arms are at least partially spring arms made of an elastic material and/or that the retaining arms are arranged at their end facing away from the magnetic ring on a support disk, which is connected to the rotor shaft, preferably to the free end of the rotor shaft, preferably connected by means of a screw connection. The use of multiple retaining arms distributes the load evenly around the magnetic ring and ensures stable and balanced mounting on the rotor shaft, thereby avoiding the risk of vibrations or imbalance during operation of the construction mixer. Especially in the case that the retaining arms are made of an elastic material, they provide sufficient flexibility and damping properties that help to absorb vibrations and shocks occurring during operation of the construction mixer, and particularly during a drop test.

According to a further particularly preferred embodiment, it is provided that the rotor shaft is rotatably mounted, at least on the side facing the magnetic ring, in a rolling bearing, the inner bearing ring and/or the outer bearing ring of which, preferably the outer bearing ring, is manufactured at least in sections from an elastomer material. Such a configuration provides additional protection against vibrations, as the elastomer material is capable of absorbing vibrations.

According to a further particularly preferred embodiment, it is provided that the electronics module, preferably on a bottom side facing the drive motor, comprises at least one plug connector for at least one cable connection, preferably for a plug connector of a cable harness bundling multiple electrical lines, by means of which the electronic components of the construction mixer, in particular the operating device and the drive motor, are electrically connectable to the control device. This results in functionally secure and advantageous contacting of the electrical components during installation or insertion of the electronics module, which helps to avoid complex wiring and the risk of incorrect assembly.

According to a further particularly preferred embodiment, the drive motor is designed as an electric motor, preferably as a brushed electric motor, which comprises a rotor and a stator. Furthermore, a brush holder with at least one carbon brush is provided, which is in contact with a commutator of the rotor. The brush holder is preferably arranged with a gap spacing on a mounting surface in the interior of the housing, in particular in the region of the lower housing part, preferably arranged in a releasable manner. The gap spacing between the brush holder and the mounting surface allows for effective flow of cooling air around the brush holder. This helps to prevent overheating of the carbon brushes and thus to prolong the service life of the electrical components. Moreover, this allows for efficient heat dissipation from the carbon brushes and other associated electrical components, i.e., the gap spacing allows the heat to be released even faster to the surrounding air, which helps to keep the operating temperature low and improve the performance of the machine.

According to a preferred specific embodiment in this regard, it is provided that the mounting surface is formed by support ribs spaced apart from one another, on which the brush holder rests with a support surface. For secure and functionally reliable positioning of the brush holder in the interior of the housing, it is provided that the mounting surface comprises centering pins, which are assigned centering recesses on the brush holder. Again, a kinematic reversal is fundamentally possible, i.e., the mounting surface may also comprise centering recesses, which are assigned centering pins on the brush holder.

The support surface of the brush holder is particularly preferably formed by a base plate, which is releasably fixed to the mounting surface by means of a snap connection, for example a hook-in and snap-fit connection. This allows for easy assembly and disassembly of the brush holder, for example in connection with cleaning purposes or when replacing the carbon brushes.

To ensure efficient cooling of the drive motor, preferably formed by an electric motor, it is provided according to a particularly preferred embodiment that the housing, preferably the lower housing part, comprises at least one air inlet opening, which is suitable and configured to allow air, preferably cooling air, to flow into the interior of the housing. In order to reliably discharge the heated cooling air from the interior of the housing, it is provided according to a further particularly preferred embodiment that the housing, preferably the lower housing part, comprises at least one air outlet opening, which is suitable and configured to allow air, preferably heated exhaust air, to flow out of the interior of the housing, preferably into the environment, wherein the at least one air outlet opening is arranged, with reference to the vertical axis direction, at a distance below the at least one air inlet opening on the housing, preferably on the lower housing part.

For efficient guidance of the cooling air and thus efficient cooling performance, it is furthermore preferably provided that the at least one air inlet opening and the at least one air outlet opening are fluidically connected in the interior of the housing by means of at least one air flow channel in such a way that the air flowing in through the at least one air inlet opening flows towards and/or around and/or through the drive motor, and that the air flowing towards and/or around and/or through the drive motor subsequently flows through the air flow channel in the direction of the at least one air outlet opening. A particularly efficient cooling performance is achieved with an embodiment in which the air flowing into the air flow channel via the at least one air inlet opening flows through the drive motor, which is formed as an electric motor, in the area of an air gap between the rotor and the stator, which forms part of the air flow channel.

The air flow channel may, according to a further particularly preferred embodiment, comprise or form at least one deflection section in the region upstream of the at least one air outlet opening and/or in the region downstream of the drive motor, preferably downstream of the rotor-stator air gap, by means of which the airflow can be deflected, with reference to the vertical axis direction, for example deflected upward or downward, preferably deflected by more than 90°, most preferably deflected by more than 90° up to 180°. In this way, on the one hand, the length ratios on the housing, in particular between the housing part receiving the drive motor and a housing part receiving a gear unit, can be advantageously realized in a shortened manner, which leads to a compact and advantageous appearance. In particular, however, the noise can also be broken due to the deflection and deviation in the region of the air flow channel, for example on the air flow channel walls, which helps to minimize noise generation during operation and to provide effective sound attenuation.

A particularly advantageous design in this context is one in which a fan wheel is provided in the housing interior, preferably mounted on the rotor shaft of the drive motor, which is arranged in the region upstream of the deflection section and downstream of the drive motor, preferably downstream of the rotor-stator air gap, and by the actuation of which air, preferably cooling air, can be drawn in through the at least one air inlet opening into the air flow channel. For a compact design, it may further be provided according to a further preferred embodiment that the at least one air outlet opening, with reference to the vertical axis direction, lies above the fan wheel.

A particularly good noise reduction or sound attenuation, which is moreover simple to implement, can also be achieved with a design in which the deflection section is overall formed in a Z-shape or S-shape, preferably for a Z-shaped or S-shaped flow deflection and/or for a substantially horizontal outflow of the air stream from the at least one air outlet opening.

Furthermore, to ensure sufficient air supply and/or air discharge, a configuration is advantageous in which the housing, preferably the lower housing part, comprises multiple air inlet openings and/or multiple air outlet openings spaced apart from one another in the circumferential direction.

A further particularly advantageous possibility for sound attenuation is provided with a configuration in which at least one sound-absorbing element is arranged in the region of the at least one air outlet opening.

Furthermore, a method for operating a manually operable construction mixer is claimed. The resulting advantages are identical to the aforementioned advantages of the manually operable construction mixer, so that reference is made to the previous explanations in order to avoid repetition.

Other features which are considered as characteristic for the invention are set forth in the appended claims.

Although the invention is illustrated and described herein as embodied in a hand-operated construction mixer, in particular a hand-operated stirring machine for stirring and/or mixing construction materials, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a perspective front view of an exemplary embodiment of a manually operable construction mixer without an electronics module and thus without a display and/or operating unit;

FIG. 2 shows a schematic perspective front view of an alternative embodiment of a manually operable construction mixer with an electronics module and a display and/or operating unit;

FIG. 3 shows an alternative embodiment to FIG. 2 with an alternative display and/or operating unit;

FIG. 4 shows a schematic perspective bottom view of a construction mixer according to the invention as shown in FIG. 3;

FIG. 5 shows a schematic top view of the construction mixer shown in FIG. 3;

FIG. 6 shows a schematic top view of the construction mixer shown in FIG. 2;

FIG. 7 shows a schematic perspective view of a crossbar of a handle unit with grip shells in a first handle position;

FIG. 8 shows a view corresponding to FIG. 7 with the grip shells in a second, wider handle position;

FIG. 9 shows a schematic cross-section through a handle in the region of a screw connection;

FIG. 10 shows a detailed view of two interaction elements formed by push buttons of the embodiment shown in FIG. 3;

FIG. 11 shows a schematic cross-section through the region of the handle shown in FIG. 10;

FIG. 12 shows a schematic and perspective top view of the region of the ring element of a crossbar in a mounted state placed onto the lower housing part, in which the connection and/or insulation ring is formed as a continuous ring running in the circumferential direction;

FIG. 12A shows an alternative schematic and perspective top view to FIG. 12 of the region of the ring element of a crossbar in a mounted state placed onto the lower housing part, in which the connection and/or insulation ring is formed by ring segments spaced apart from one another;

FIG. 13 shows a sectional view of a section taken along the line A-A in FIG. 12 with the housing cover mounted at the same time;

FIG. 14 shows a view corresponding to FIG. 12 without crossbar;

FIG. 14A shows a view corresponding to FIG. 12A without crossbar;

FIG. 15 shows a sectional view of a section taken along the line B-B in FIG. 5;

FIG. 16 shows a schematic and perspective top view of the connection and/or insulation ring with mounted electronics module, wherein the connection and/or insulation ring is formed as a continuous ring running in the circumferential direction;

FIG. 16A shows a schematic and perspective top view of the connection and/or insulation ring with mounted electronics module, wherein the connection and/or insulation ring is formed by ring segments spaced apart from one another;

FIG. 17 shows a sectional view of a section taken along the line C-C in FIG. 12;

FIG. 18 shows a schematic perspective view of the rotor with a magnetic ring arranged at the end of the rotor shaft;

FIG. 19 shows the magnetic ring of FIG. 18 in a perspective bottom view;

FIG. 20 shows the magnetic ring according to FIGS. 18 and 19 in a perspective top view;

FIG. 21 shows a cross-section through the end region of the rotor or rotor shaft with the mounted magnetic ring;

FIG. 22 shows a schematic perspective view of the lower housing part acting as a motor housing with brush holder;

FIG. 23 shows the brush holder shown alone;

FIG. 24 shows a schematic sectional view of a section taken along the line D-D in FIG. 22;

FIG. 25 shows a schematic bottom view of the electronics module;

FIG. 26 shows a view corresponding to FIG. 12 with a plug connector arranged in the housing interior;

FIG. 27 shows a schematic top view of the display and/or operating unit according to the embodiment of FIG. 2 in the switched-off state;

FIG. 28 shows a schematic top view of the display and/or operating unit according to the embodiment of FIG. 3 in the switched-off state;

FIG. 29 shows a view corresponding to FIG. 28 at the start of activation of the construction mixer;

FIG. 30 shows a view corresponding to FIG. 29 after a mixing time of 1 minute and 22 seconds;

FIG. 31 shows a view corresponding to FIG. 29, in which, in contrast to the view in FIG. 29, the speed is displayed instead of the time;

FIG. 32 shows a view corresponding to FIG. 30, in which, in contrast to the view in FIG. 30, the speed is displayed instead of the time;

FIG. 33 shows a view corresponding to FIG. 27 with the construction mixer activated and low speed set;

FIG. 34 shows a view corresponding to FIG. 27 with the construction mixer activated and high speed set;

FIG. 35 shows a longitudinal cross-section through the manually operable construction mixer shown in FIG. 2 without a sound-damping element;

FIG. 36 shows an alternative longitudinal section to FIG. 35 through the manually operable construction mixer shown in FIG. 2 without a sound-damping element;

FIG. 37 shows a longitudinal cross-section through the manually operable construction mixer shown in FIG. 2 with a sound-damping element; and

FIG. 38 shows an alternative longitudinal section to FIG. 37 through the manually operable construction mixer shown in FIG. 2 with a sound-damping element.

### DETAILED DESCRIPTION OF THE INVENTION

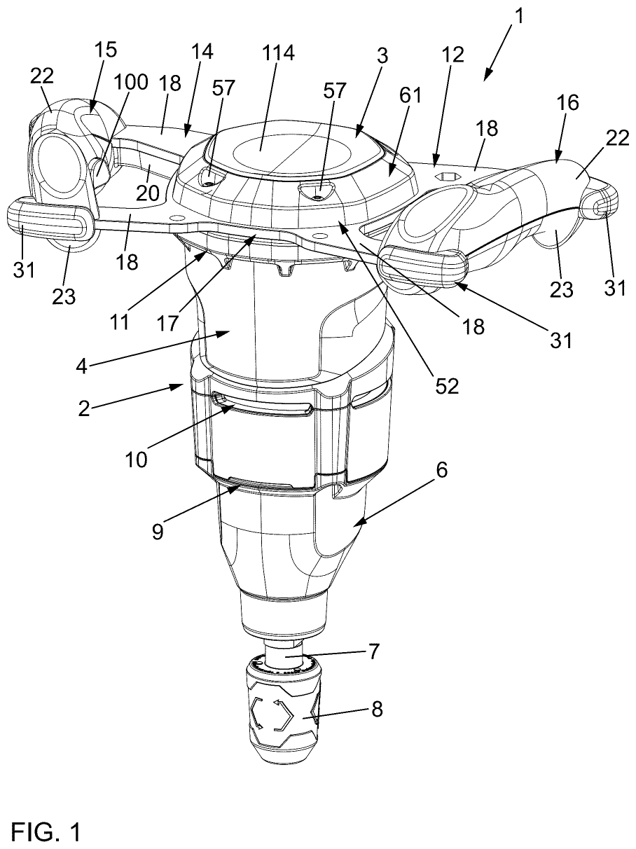

Referring now to the figures of the drawing in detail and first, in particular, to FIGS. 1 to 3, there are shown perspective views of an exemplary embodiment of a construction mixer 1 according to the invention, whose basic design is the same through the three figures, but which differ in a manner to be described in more detail with regard to the use of an electronics module and the electronic functional units.

Each of the construction mixers 1 according to the invention comprises a housing 2, which in the present case is formed in two parts and comprises, in relation to the usage position of the construction mixer 1 shown in FIGS. 1 to 3, an upper housing part which forms a housing cover 3 and is connected, in a manner yet to be described, to a lower housing part 4, which in the present case is formed as a one-piece component and functions as a motor housing.

In the housing 2 or in the lower housing part 4, a drive motor 5 formed as an electric motor is received, which in the present example further comprises a transmission 6, and the drive shaft 7 of which is routed out of the lower housing part 4 on the transmission side, the drive shaft 7 being provided at its end with a connection element 8, for example a quick-release coupling, via which a mixing and/or stirring tool, not shown here, for example a shaft of a stirring rod of the drive shaft 7, can be operatively connected, i.e., can be rotationally driven.

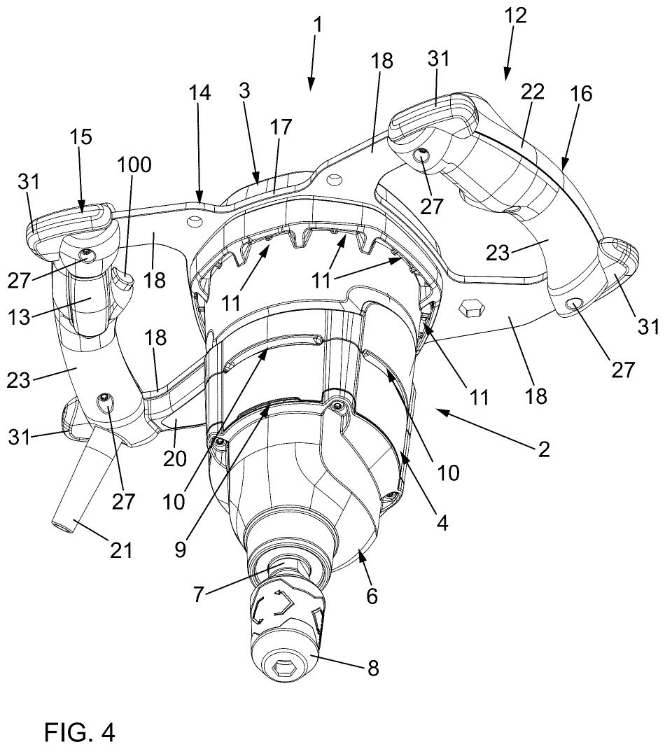

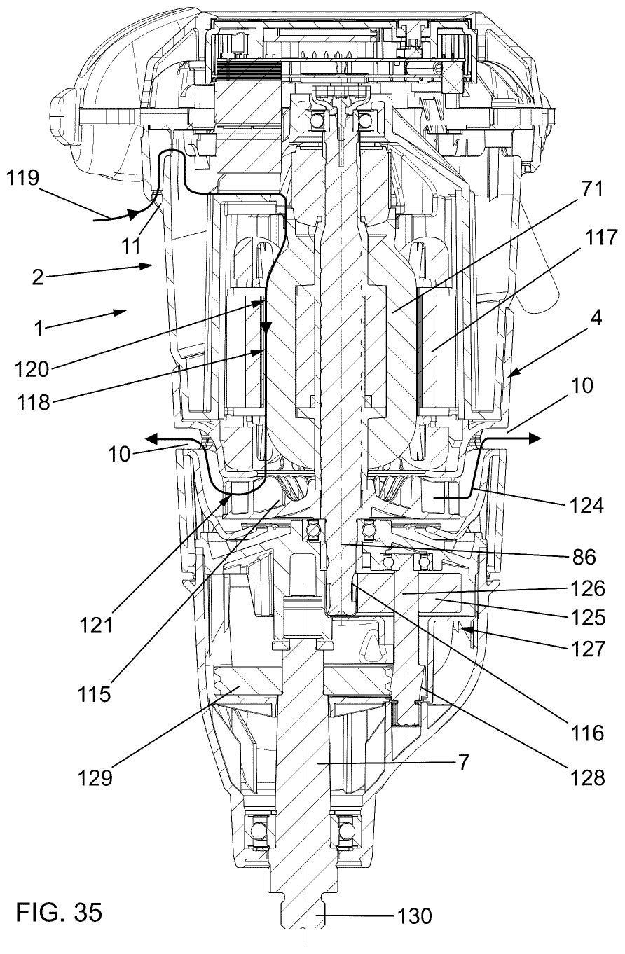

As is particularly evident from FIG. 4, the lower housing part 4 is formed with a plurality of housing openings, formed in the present case merely by way of example as air slots 10 and 11, spaced apart from one another in the circumferential direction and spaced apart from one another in the vertical axis direction. The air slots 11 respectively form air inlet openings through which air can flow into the housing 2 as cooling air, and the air slots 10 respectively form air outlet openings through which the warmed air can flow out of the housing 2 as exhaust air. The suction of the cooling air is effected here, by way of example, via a fan wheel 115 shown in the sectional views of FIGS. 35 to 38, which is rotatably arranged in the lower housing part 4 in the region near the transmission on a rotor shaft 86 of the drive motor 5 that forms a motor output shaft.

As can be seen from FIGS. 35 to 38, the drive motor 5 is an electric motor with a rotor 71, which is rotationally fixed to the rotor shaft 86, and a stator 117 that is stationarily arranged. The air inlet openings formed by the air slots 11 and the air outlet openings formed by the air slots 10 being connected to one another in terms of flow within the housing interior 35 via an air flow channel 120 in such a way that the air flowing into the air flow channel 120 through the air slots 11 flows through the drive motor 5 formed as an electric motor in the region of a rotor-stator air gap 118, formed between the rotor 71 and the stator 117 and constituting a part of the air flow channel 120, the air flowing through the drive motor 5 subsequently continuing through the air flow channel 120 in the direction of the air outlet openings formed by the air slots 10.

As is clearly visible from FIGS. 35 to 38, it is provided here that the air flow channel 120 in the region upstream of the air outlet openings formed by the air slots 10 and in the region downstream of the rotor-stator air gap 118 forms or comprises a deflection section 121, by means of which the air stream 122 can be deflected upward with respect to the vertical axis direction in the exemplary embodiment shown here. In this exemplary case, the air stream 122 is preferably deflected by more than 90°, or by more than 90° up to a maximum of 180°.

Further, a fan wheel 115, in this case mounted on the drive shaft 7 of the drive motor 5, may be provided in the housing interior 35, which is arranged in the region upstream of the deflection section 121 and downstream of the rotor-stator air gap 118 and by the actuation of which cooling air 119 is drawn in through the air slots 11 into the air flow channel 120.

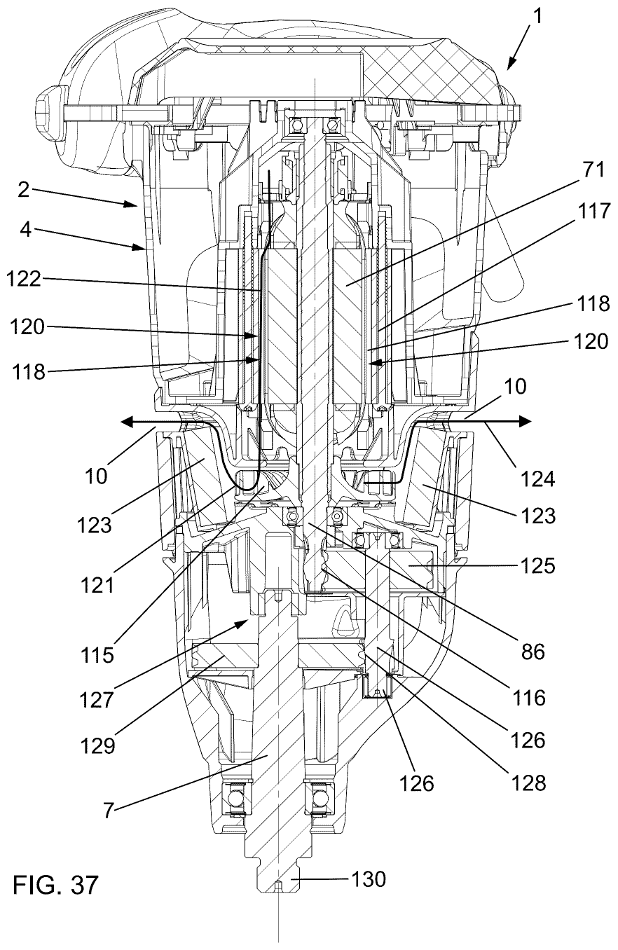

As can also be seen from FIGS. 35 to 38, the deflection section 121 is formed in an overall Z-shaped or S-shaped manner (see in each case the flow portion 124 shown on the right side of FIGS. 35 and 37), i.e., the deflection section 121 causes a Z-shaped or S-shaped flow deflection in order to achieve sufficient noise breaking in combination with a substantially horizontal outflow of the air stream 122 from the air slots 10.

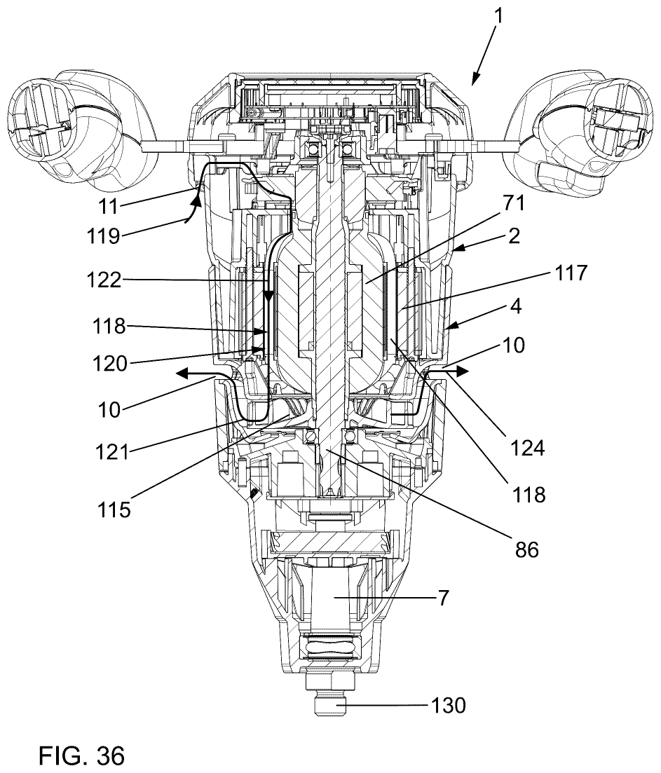

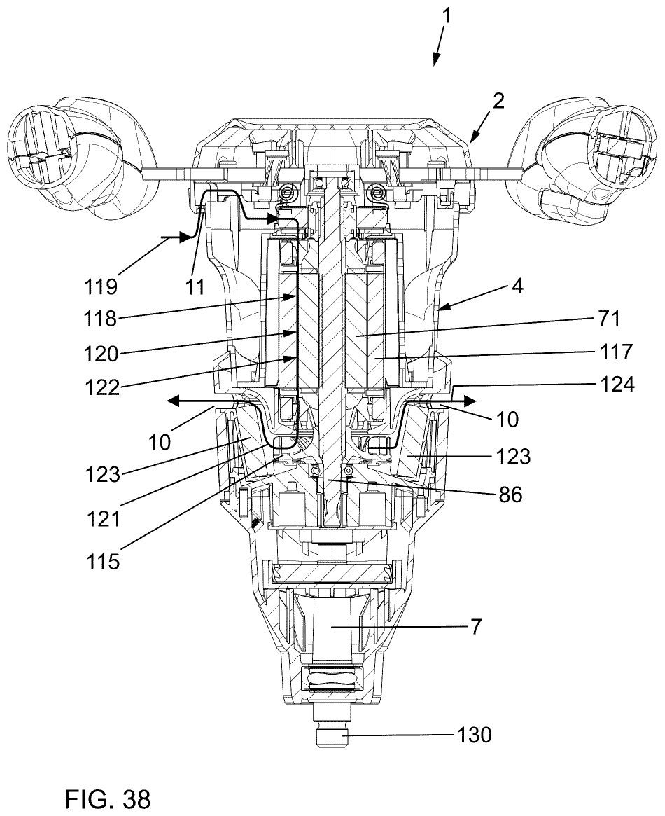

In contrast with the embodiment according to FIGS. 35 and 36, the embodiment of the construction mixer 1 according to FIGS. 37 and 38 further comprises a sound-damping element 123 in the region of the air slots 10.

The rotor shaft 86 comprises an external gearing 116 which meshes with a spur gear 129 of a transmission shaft 126 of a transmission 127. The transmission shaft 126 further comprises an output gearing 128 which meshes with a spur gear 129 of the drive shaft 7. As further visible from FIGS. 35 to 38, the drive shaft 7 is routed out of the housing 2 and is provided at its end with a connection element 130, for example a quick-release coupling, for a shaft of a stirring rod or the like, not shown here, of a mixing and/or stirring tool.

Upon the actuation of the drive motor 5, which in this example is an electric motor, the rotor shaft 86 functioning as the motor output shaft is rotationally driven via the transmission 17 with a correspondingly defined gear ratio (for example, 26:1), thereby also rotationally driving the drive shaft 7 of the construction mixer 1 and thus a mixing and/or stirring tool, such as a stirring rod, connected to this drive shaft 7.

With such a configuration, motor speeds of the drive motor 5 at the rotor shaft 86 of 16,000 to 17,000 rpm can, for example, achieve an advantageous load speed at the drive shaft 7 of preferably 300 rpm to 750 rpm.

As can also be seen from FIGS. 1 to 4, the construction mixer 1 comprises a handle assembly 12, which is connected to the housing 2 in a manner yet to be described.

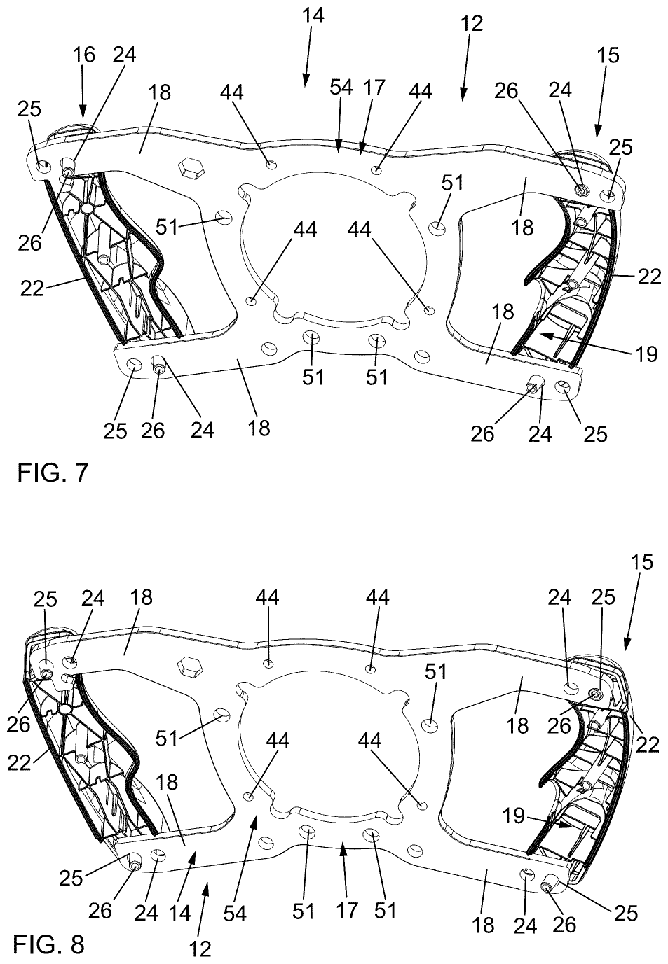

As is also clearly visible from FIGS. 1 to 4, the handle assembly 12 comprises a crossbar 14, formed in one piece in the present case, as a grip bar, which comprises two handles 15, 16 that are arranged on mutually opposing transverse bar sides of a ring element 17 located in a central region between the two handles (see FIGS. 7 and 8). Each handle 15, 16 is connected to the ring element 17, which in the present case is located centrally and in the middle between the two handles 15, 16, via transverse struts 18 which extend radially from the ring element 17 and are spaced apart in such a manner that the transverse struts 18 together with their associated handles 15, 16 are formed approximately U-shaped, the handles 15, 16 essentially forming or constituting the U-base.

As is particularly evident from FIG. 4, an actuation device 13 of the construction mixer 1, which in this example is formed as a hand switch, is a component of the handle 15, for which purpose the handle 15, as particularly apparent from FIGS. 7 and 8, comprises a hollow and/or receiving space 19 in which a part of the actuation device 13, which can be actuated and accessed from the outside, is housed and received. The actuation device 13 formed by a hand switch 13 is connected via a cable connection, not shown here, extending from the actuation device 13 initially inside the handle 15 through one of the transverse struts 18 of the crossbar 14, encapsulated toward the outside by means of a transverse strut-side protective shell 20, to the housing 2 and further, in a manner yet to be described, to a control unit or to an electronic module.

As is further visible from FIG. 4, the actuation device 13 is arranged, in relation to the usage position of the construction mixer 1, on an underside of the handle 15, so that actuation of the actuation device 13 can be performed, for example, using the index finger and/or middle finger.

As is further apparent from FIG. 4, a power cord 21 (not shown in its entirety) for supplying power to the construction mixer 1 is also arranged on the handle 15, which preferably likewise opens into the hollow and/or receiving space 19 of the handle 15, wherein a likewise not illustrated cable connection extends from the power cord 21 through the hollow and/or receiving space 19 of the handle 15 and through the transverse strut 18 of the crossbar 14, encapsulated by means of the protective shell 20, to the housing 2 and, in a manner yet to be described, to the electronic components to be supplied with power or electricity.

The power cord 21 preferably exits the handle 15 on a side facing the user.

As can be seen in particular from the combination of FIGS. 7, 8, and 9, the two handles 15, 16 are each formed by an upper grip shell 22 and a lower grip shell 23, which are connected to each other and to the transverse struts 18 in such a way that on each side of the crossbar two mutually spaced transverse strut ends of two spaced transverse struts 18 serve to secure and support the two grip shells 22, 23, which receive the associated transverse strut sections between them and preferably clamp them between one another.

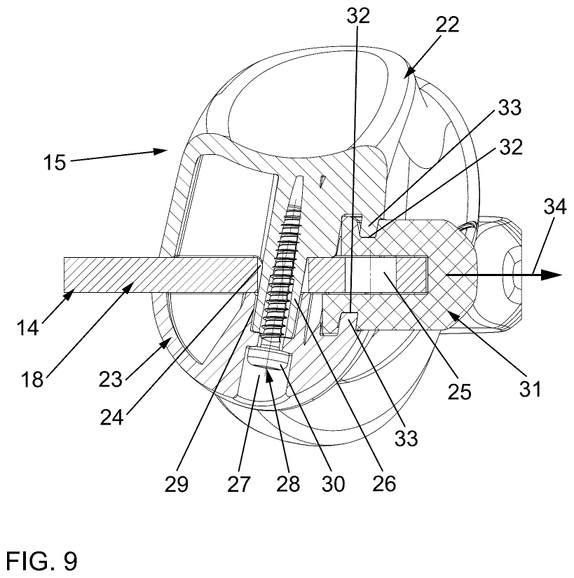

To this end, each of the transverse strut ends associated with a handle 15, 16 comprises, in the example shown here, two positions holes 24, 25 spaced apart from one another in the longitudinal direction of the transverse struts. Furthermore, two grip shell-side screw domes 26, spaced apart from one another in the longitudinal direction of the handle, are arranged on a first, upper grip shell 22 of the handle 15, 16, which comprise an internal thread and in the assembled state of the handles 15, 16 are assigned to one position hole 24 of the two transverse strut ends and engage in or extend through it, and are further assigned to a grip shell-side through-screw opening 27 of a second, lower grip shell 23 of the handles 15, 16 (see in particular FIG. 9).

As is clearly visible in FIG. 9, the two grip shells 22, 23 rest against and abut the transverse strut ends of the transverse struts 18 in the assembled state and are connected to each other by means of a screw connection, wherein a fastening screw 28 is screwed through the through-screw opening 27 and the associated position hole 24 into the assigned screw dome 26. As can also be clearly seen in FIG. 9, the screw domes 26 engage in a peg-like manner or essentially in a shape- and contour-conforming manner in a recess 29 formed at the through-screw opening side in the assembled state, and in addition, both grip shells 22, 23 are additionally supported in contact against the transverse strut ends.

As usual, the fastening screws 28 here comprise a screw head 30 which, in the assembled state, is supported on a bearing area surrounding the through-screw opening 27.

This ensures that the transverse strut ends are reliably and functionally securely clamped between the two grip shells 22, 23. As is clearly shown from the combination of FIGS. 7 and 8, the two handles 15, 16, represented here by their upper grip shells 22, are, due to their arrangement on the transverse struts 18 via the position holes 24, arranged closer to the ring element 17 and thus in the assembled state closer to the housing 2 than is the case in FIG. 8, in which the handles are fastened to the transverse struts 18 via the outer position holes 25. Accordingly, FIGS. 7 and 8 schematically and exemplarily illustrate that different grip widths of the handle assembly 12 for the construction mixer 1 can be set using the position holes 24 and 25, i.e., for example, a narrow grip position (FIG. 7) and a wide grip position (FIG. 8).

The position holes 24, 25 of each transverse strut end may, for example, have a spacing of between 10 mm and 50 mm, for example a spacing of 15 mm. Even though this is not illustrated here, of course, different arrangements and groupings of position holes can also be provided, such as more than two position holes or also a differing number of position holes, provided that it is ensured in each case that the respective position holes can be engaged by the screw domes 26 assigned to the handles 15 or 16. Accordingly, it is important in the design of the transverse struts 18 with their position holes 24, 25 to ensure that the pairs of position holes assigned to the spaced-apart screw domes 26 of a handle 15 or 16 on different transverse struts 18 always have the same spacing from one another.

The position holes 24, 25 shown here allow for a stepwise adjustment and variation of the grip width. Alternatively, however, a slot-shaped recess could also be provided, by means of which the spacing could optionally also be adjusted continuously, particularly in conjunction with a clamping of the transverse strut ends between the two grip shells 22, 23 by means of a screw connection, as shown in FIG. 9.

The grip shells 22, 23, and thus the handles 15, 16, are preferably made of a plastic material, while the crossbar 14 is preferably made of a metal and/or has the flat shape shown in FIGS. 7 and 8. Such a grip bar 14 may, for example, be cut from a metal or steel plate. This flat shape of the crossbar 14 is also advantageous if it is optionally made from another material, for example a plastic material. In general terms, the crossbar 14 thus has a flat or plate-like cross-section, for example with a rectangular or elongated oval cross-sectional geometry.

As is further evident in particular from the combination of FIGS. 1 to 4 with FIG. 9, the transverse struts 18 extend beyond the handles 15, 16 mounted thereon with a drop-protection overhang, which in this case is formed by a buffer element 31 that can be pushed onto the transverse strut ends and is preferably made of an elastomer material.

As can be seen particularly from FIG. 9, the buffer elements 31 are clamped between the grip shells 22, 23 in the assembled state.

To enable an adjustment of the position of the buffer elements 31 for the different grip widths shown in FIGS. 7 and 8, the buffer elements 31 are mounted on the transverse strut ends so as to be displaceable in the longitudinal direction of the transverse struts. The buffer elements 31 each have, on opposite sides facing the grip shells 22, 23, a locking element 32 which interacts with a locking counter-element 33 on the respectively associated grip shells 22, 23 such that the locking elements 32 and the locking counter-elements 33 engage and cooperate in a shape- and/or contour-conforming manner.

FIG. 9 shows the example case according to FIG. 7, in which both handles 15, 16 are in the narrow grip position. If the wide grip position shown in FIG. 8 is to be set, then the handle can be positioned at the transverse strut ends via the position hole 25, which is unoccupied in FIG. 9. To do so, the buffer element 31 can be shifted outward (arrow 34) or repositioned in the manner shown in FIG. 9, in which the buffer element 31 remains mounted on the associated transverse strut end but releases the position hole 25 (not shown here).

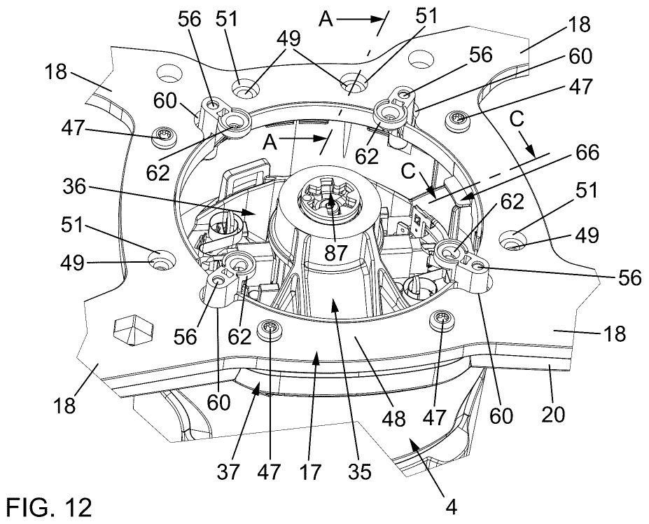

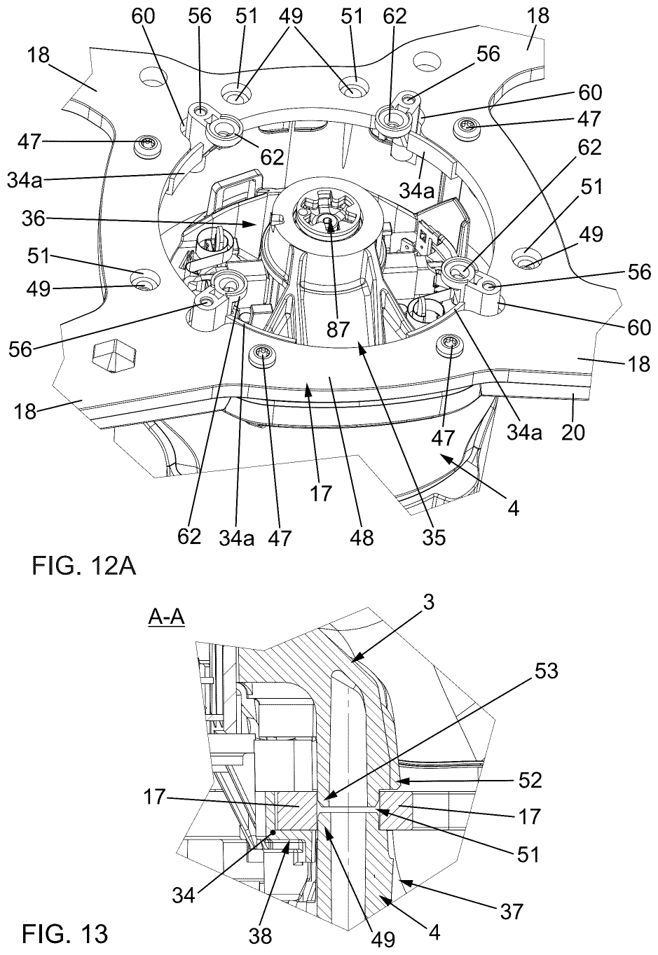

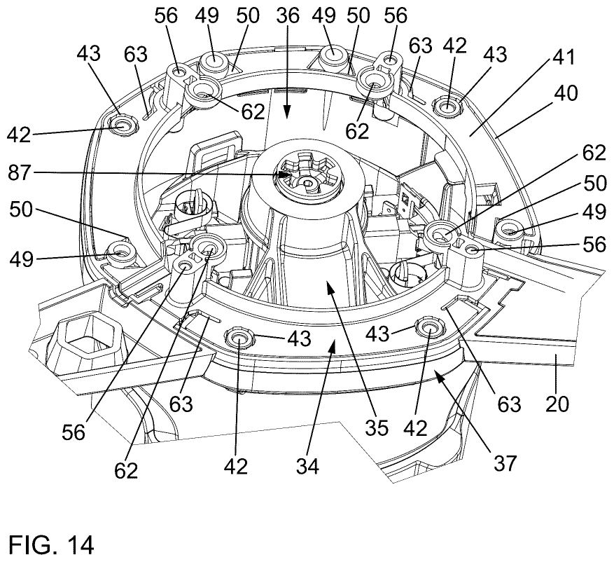

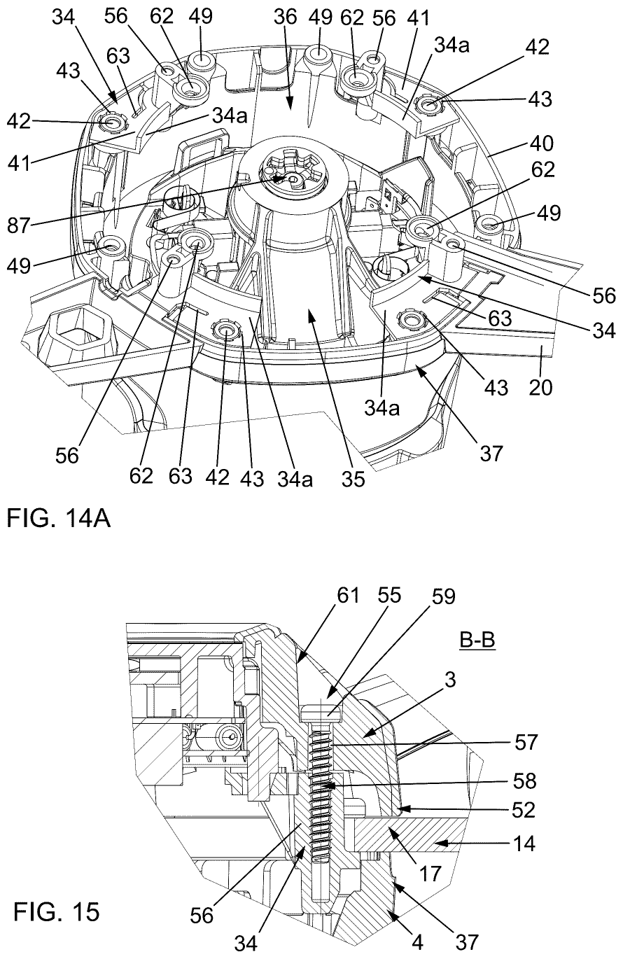

As is particularly evident from the combination of FIGS. 12 and 14, the ring element 17 of the crossbar 14 is connected to the lower housing part 4 via an interposed connection and/or insulation ring 34, wherein the connection and/or insulation ring 34, just like the ring element 17 in the example shown here, surrounds the housing interior 35 in a ring-shaped manner and is supported and fixed at an opening edge region 37 of the lower housing part 4 that forms the housing opening 36. To this end, the opening edge region 37 of the lower housing part 4, as can be seen in particular from FIG. 22, has a circumferential support and receiving surface 38 on which the connection and/or insulation ring 34 rests. The support and receiving surface 38 is in this case partially formed by ribs 39 that are formed at the opening edge region 37 and spaced apart circumferentially.

According to an alternative embodiment, which is particularly evident from the combination of FIGS. 12A and 14A, the connection and/or insulation ring 34 can also be formed by multiple ring segments 34a that are spaced apart from one another in the circumferential direction.

As is further evident from FIG. 22, the support and receiving surface 38 is offset downward relative to an outer circumferential edge 40 of the opening edge region 37, and specifically here by way of example by the thickness or material thickness of the connection and/or insulation ring 34, in such a manner that, in the assembled state of the connection and/or insulation ring 34, the upper edge of the circumferential edge 40 is essentially flush with an upper surface 41 (see FIG. 14 and FIG. 14A) of the connection and/or insulation ring 34 and together they form a substantially planar support surface for the ring element 17 of the crossbar 14.

As is also evident from FIG. 22, the support and receiving surface 38 has several screw domes 42 spaced apart in the circumferential direction of the opening edge region 37, each having an internal thread and being associated with through openings 43 on the connection and/or insulation ring 34 (see FIG. 14) and through openings on the ring element (see in particular FIGS. 7 and 8). As can be seen in particular from FIG. 22, the screw domes 42 project in a pin-like manner from the support and receiving surface 38 and, as can be seen again from FIG. 14, protrude into the associated through openings 43 on the connection and/or insulation ring 34.

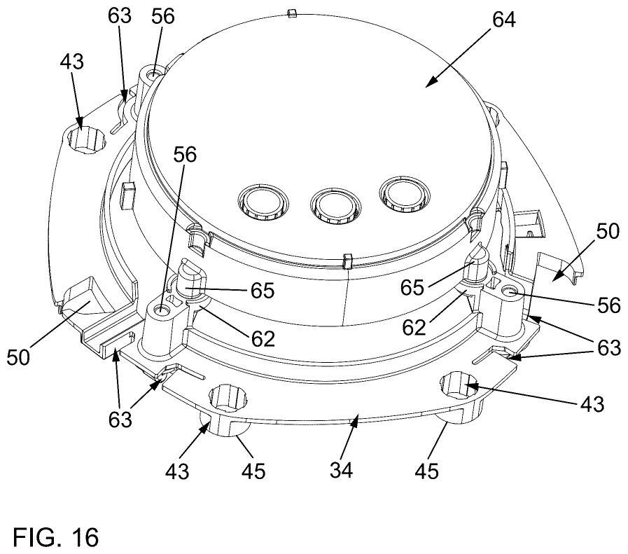

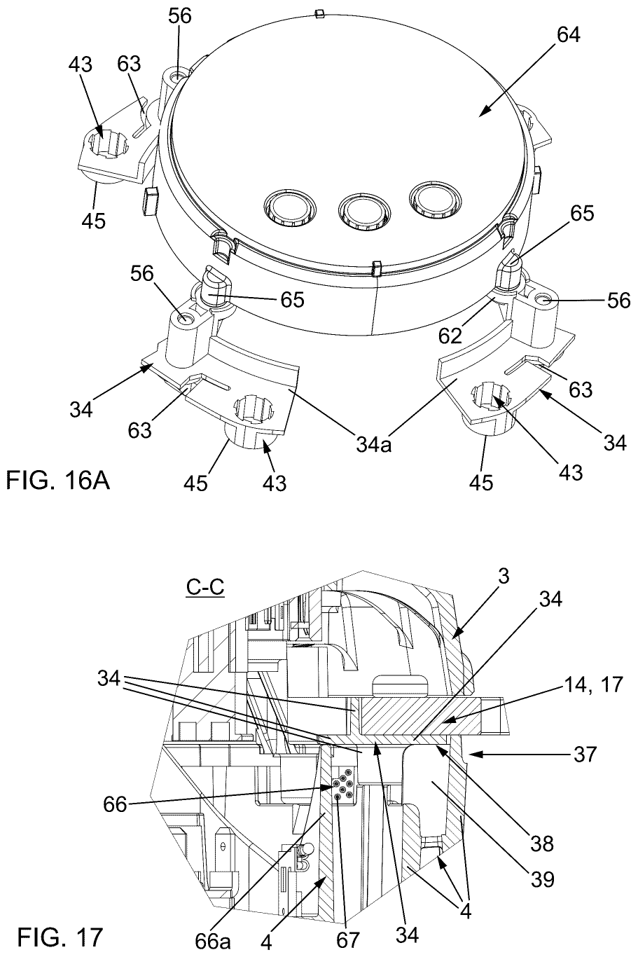

As can be seen in particular from FIG. 16, the through openings 43 on the connection and/or insulation ring 34 can be formed in the manner of pipe sockets and have an oversize relative to the screw domes 42 of the support and receiving surface 38 such that, in the assembled state, their free end-face region 45 accommodates the respective screw dome 42 inside the through opening 43 and rests around the respectively associated screw dome 42 on a support area 46 (see FIG. 22) of the support and receiving surface 38. The same applies analogously to the alternative embodiment shown in FIG. 16A, in which the connection and/or insulation ring 34 is formed by the ring segments 34a.

As can be seen in particular from FIG. 12, to fasten the ring element 17, fastening screws 47 are screwed in from the top side 48 of the ring element 17 through the through openings 43 in the connection and/or insulation ring 34 and through the through openings 44 in the ring element 17 into the screw domes 42.

It should again be expressly noted here that in all embodiments in which components such as the screw domes are provided with an internal thread, this internal thread can either already be pre-formed in the component or be created by screwing in the fastening screw into the component.

As is also evident from FIG. 22, the support and receiving surface 38 further has several centering pins 49 spaced apart in the circumferential direction of the opening edge region 37, which are associated with centering openings 50 on the connection and/or insulation ring 34 (see FIGS. 14 and 16) and centering openings 51 on the ring element 17 (see FIGS. 7, 8, and 12), such that the centering pins 49 project from the support and receiving surface 38 in such a way that they pass through the centering openings 50 on the connection and/or insulation ring 34 from below and at least partially protrude into the associated centering openings 51 on the ring element 17. This is particularly well illustrated in FIG. 12 and the sectional view in FIG. 13, which shows a section taken along the line A-A in FIG. 12.

In the alternative embodiment of a connection and/or insulation ring 34 formed by several ring segments 34a spaced apart from one another (FIGS. 12A, 14A, and 16A), centering openings 50 assigned to the centering pins 49 may in principle also be provided on the ring segments 34a by corresponding segment design. However, in the preferred embodiment shown here (FIGS. 12A, 14A, and 16A), the ring segments 34a are designed in such a way that no centering openings 50 assigned to the centering pins 49 are provided or required. In this embodiment (see in particular FIG. 12A), only the centering openings 51 on the ring element 17 are assigned to the centering pins 49 of the support and receiving surface 38 such that the centering pins 49 project upward from the support and receiving surface 38 in the direction of the associated centering openings 51 on the ring element 17 and optionally at least partially engage in the centering openings 51 on the ring element 17.

FIG. 13 further shows that, in the assembled state, the housing cover 3 rests with a circumferential edge region 52 (see also FIGS. 1 to 3) on the ring element 17 and is supported thereon, with the housing cover 3 having, on its underside, centering pins 53 assigned to the centering openings 51 of the ring element 17 (see FIG. 13), which in the assembled state of the housing cover 3 also at least partially engage from above into the associated centering openings 51 on the ring element 17, preferably in such a way, as shown in FIG. 13, that the free ends of the centering pins 53 on the housing cover side maintain a gap distance from the centering pins 49 on the support and receiving surface side, which also engage in the centering openings.

It can therefore also be seen that the centering openings 51 on the ring element enable functionally reliable alignment and positioning of the housing cover 3 on the ring element 17, wherein the ring element 17, in the assembled state, lies with a flat contact surface area 54 (see in particular FIGS. 7 and 8) in a surface contact connection on the likewise flat upper side 41 of the connection and/or insulation ring 34 facing the ring element. In particular in connection with a drop test, this also enables advantageous force transmission via the cover and the ring element into the lower housing part.

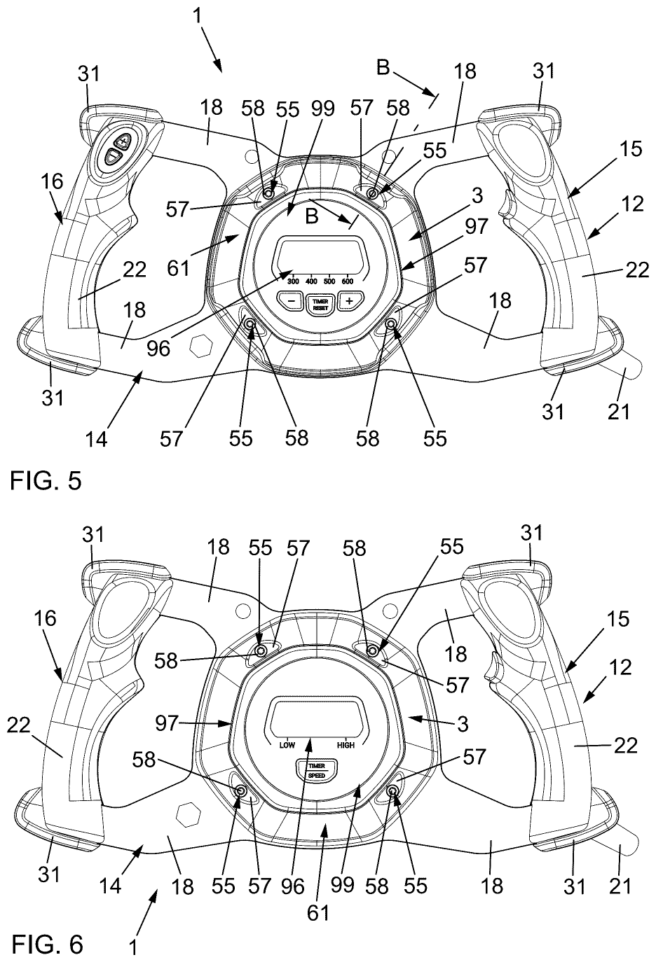

As is further evident in particular from the combination of FIGS. 5 and 6 and FIG. 15, the housing cover 3 is detachably screwed to the connection and/or insulation ring 34 by means of multiple screw connections 55, while being supported with its circumferential edge region 52 on the ring element 17. For this purpose, the connection and/or insulation ring 34, as can clearly be seen from FIG. 14, has multiple screw-in elements 56 spaced apart from one another in the circumferential direction of the opening edge region 37, which are here formed as pin-like screw domes with an internal thread projecting from the connection and/or insulation ring 34 in the direction of the housing cover 3. These screw-in elements 56 are assigned through openings 57 formed on the housing cover 3 and spaced from one another in the circumferential direction, such that to establish the screw connection, a fastening screw 58 can be screwed from the outside of the cover through the respective through opening 57 into the associated screw-in element, whereby each fastening screw 58 is supported with its screw head 59 on an edge region of the associated through opening 57 (see in particular FIG. 15).

As can be seen in particular from FIG. 12, the screw-in elements 56 formed as pin-like screw domes are associated with, here by way of example, edge-side dome recesses 60 in the ring element 17, wherein the screw-in elements 56 formed as screw domes in the exemplary embodiment shown here extend through the edge-side dome recesses 60 in such a way that they protrude beyond the upper side 48 of the ring element 17 facing the housing cover 3.

As is particularly evident from FIGS. 1 to 3, the housing cover 3 is preferably formed as a dome-shaped housing cover that has a circumferential lateral wall section 61 in which the cover-side through openings 57 are formed at intervals. As is particularly evident from FIG. 15, which shows a section taken along the line B-B in FIGS. 5 and 6, the cover-side through openings 57 are here formed by pin-like pipe sockets projecting from the underside of the lateral wall section 61, which, in the assembled state, are aligned with and directly adjacent to, preferably abutting, or—as shown in FIG. 15—with a minimal gap adjacent to, the screw-in elements 56 formed here as screw domes.

As is especially evident from FIGS. 1 to 3 as well as from FIGS. 5 and 6, the housing cover 3 in the assembled state lies on the ring element 17 of the crossbar 14 in such a way that it essentially follows the outer circumferential contour of the ring element 17 and that the fastening screws 47 for securing the ring element 17 to the opening edge region 37 or to the lower housing part 4 lie inside the housing cover 3.

As is especially evident from FIGS. 12 and 14, the screw-in elements 56 formed here as screw domes are integrally and monolithically connected to retaining elements 62, which in radial view are directly adjacent to the screw-in elements 56 and are here, by way of example, formed by retaining rings with a ring opening. Accordingly, the retaining elements 62 extend from the opening edge region 37 into the housing opening 36 of the lower housing part 4.

As is particularly evident from FIGS. 14 and 16, the mutually combined retaining elements 62 and screw-in elements 56 are elastically resiliently connected to the connection and/or insulation ring 34, namely by means of a relief cut 63, which causes the component assembly consisting of each screw-in element 56 together with retaining element 62 to be partially suspended from the connection and/or insulation ring 34.

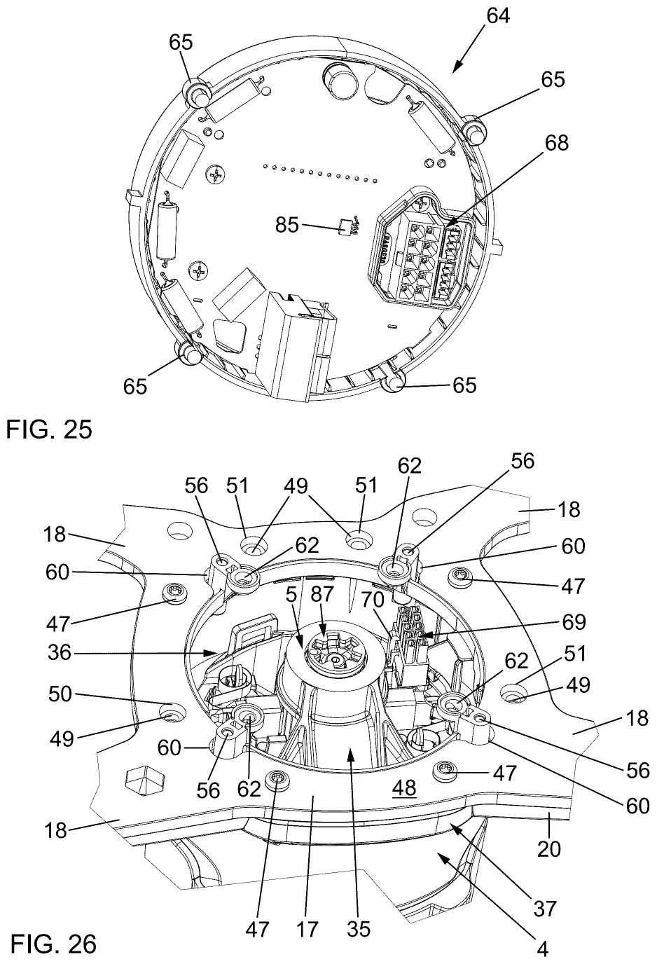

The retaining elements 62 specifically form a retaining device for an electronics module 64, which is shown in FIG. 25 in a perspective bottom view. On the underside of the electronics module 64 shown in FIG. 25, radially spaced retaining pins 65 are arranged on the outer circumference as counter retaining elements, which, in the mounted state (see FIG. 16), engage in the retaining elements 62 formed by the retaining rings, so that the electronics module 64 is also supported and retained on the connection and/or insulation ring 34.

As further shown in FIG. 12 and in particular in FIG. 17, which shows a sectional view of a section taken along the line C-C in FIG. 12, the connection and/or insulation ring 34, here by way of example on its underside facing away from the ring element 17, forms a spacer 66 in conjunction with a spacer wall 66a of the lower housing part 4, by which electrical lines 67 are kept at a distance in particular from the ring element 17. The connection and/or insulation ring 34, which is made of an electrically non-conductive material, preferably plastic, thus shields, as is clearly visible in FIG. 17, the electrical lines 67 from the ring element 17 or crossbar 14, which is preferably made of steel or metal, and also bundles the electrical lines 67 in a wall-adjacent region of the lower housing part 4, so that they can be routed from there with short cable lengths to the electronic components.

As is further evident from the combination of FIGS. 25 and 26, the electronics module 64 has on its underside shown in FIG. 25 a plug connector 68 for a plug 69 of a cable connection, for example a cable harness (not shown in detail here), by means of which the electronic components of the mixer 1 can be electrically connected to the electronics module 64 and thus also to the control unit forming part of the electronics module 64. The plug 69 is here arranged in the housing interior 35 in the region of the lower housing part 4 (FIG. 26), preferably held there releasably by means of a latching connection 70 formed, for example, as a snap connection.

The plug connector 68 on the electronics module 64 and the plug 69 in the lower housing part 4 are arranged and designed such that the plug connection between the two components is established in the mounted state of the electronics module 64 as shown in FIG. 16.

As is further apparent from the combination of FIGS. 22 to 24, the drive motor 5, which is designed as an electric motor, preferably as a brushed electric motor, has a stator (not shown) and a rotor 71 (see in particular FIG. 24), wherein the rotor 71, or preferably a commutator of the rotor 71, is in contact with a carbon brush 72, which is held by a carbon brush holder 73.

As is particularly evident from FIG. 24, this carbon brush holder 73 is arranged with a gap on a mounting surface 74 in the region of the lower housing part 4, preferably releasably arranged, wherein the mounting surface 74 is formed here by several spaced-apart support ribs 75 on which the carbon brush holder 73 lies with a contact surface formed by a base plate 76. The mounting surface 74 further comprises two spaced-apart centering pins 77, which are assigned centering recesses 78 on the carbon brush holder 73 or, in the present example, on the base plate 76. In the mounted state shown in FIG. 24, the centering pins 77 engage in a form-fitting and contour-matching manner in the centering recesses 78, so that the carbon brush holder 73 together with its carbon brush is positioned and oriented precisely.

For the detachable retention of the carbon brush holder 73 or its base plate 76 on the mounting surface 74, a releasable latching connection 79 is provided. Specifically, the latching connection 79 is formed here by a hook-in and snap-in connection, in which initially a left-hand portion of the base plate 76 in the plane of FIG. 24 is threaded beneath a hook-in element 80, then the carbon brush holder 73 is pivoted downward toward the mounting surface 74 until a right-hand snap-in element 81 in the plane of FIG. 24 snaps into a hooked-in position under a hook-in element 82 and is releasably locked there in the fully mounted position shown in FIG. 24.

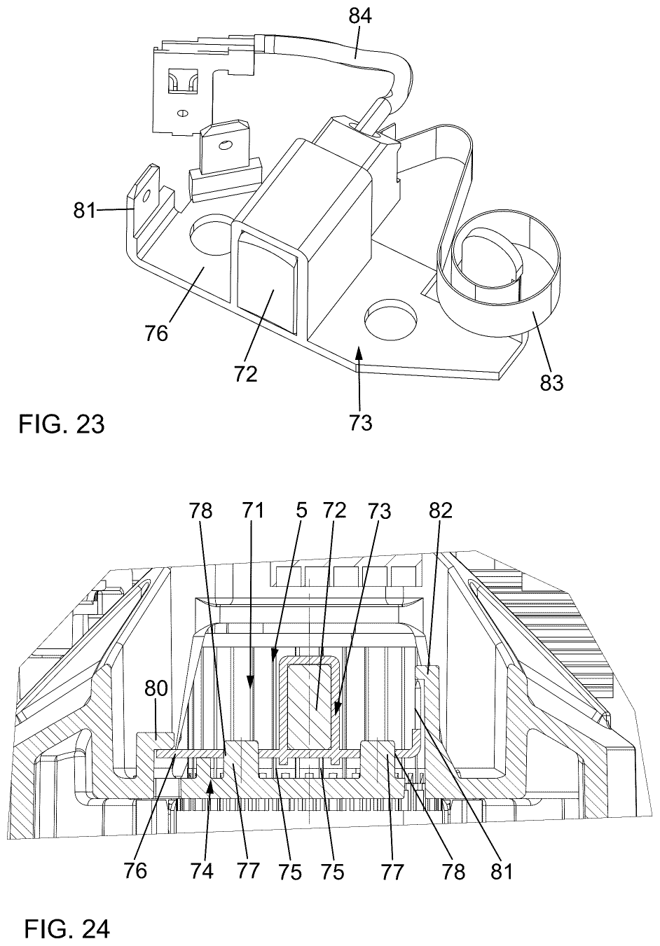

As is particularly evident from the combination of FIGS. 22 and 23, the carbon brush holder 73 further comprises a spring element 83, which is formed here as a coil spring and presses the carbon brush 72 toward the rotor 71, ensuring secure contact of the carbon brush 72 with the rotor 71 or the commutator of the rotor 71. An electrical wire 84 is used to transmit electrical current to the carbon brush 72, which in turn transfers the current, for example, to the commutator of the electric motor in order to power the rotor 71 and set it in motion.

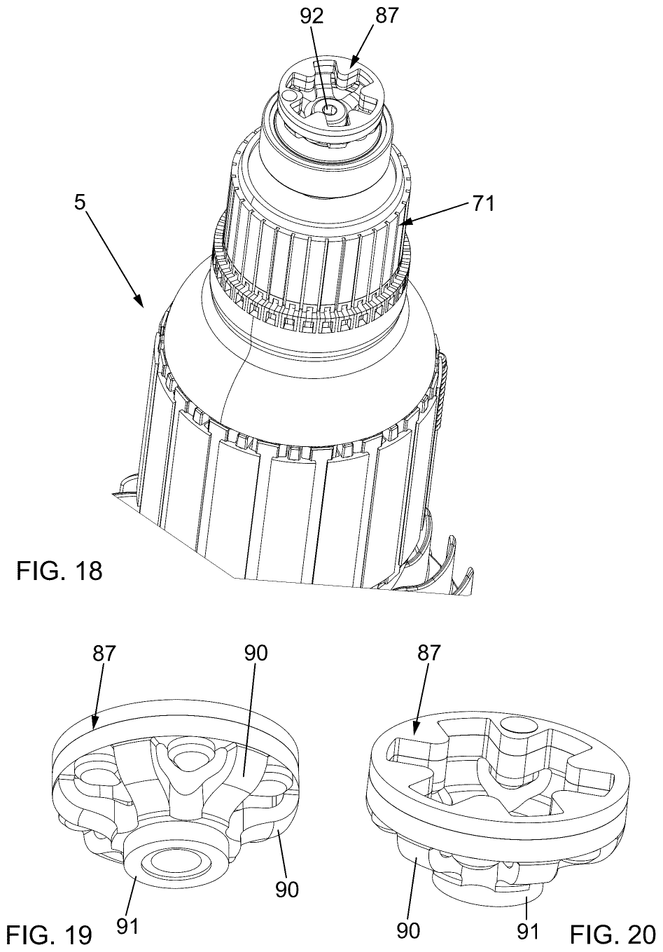

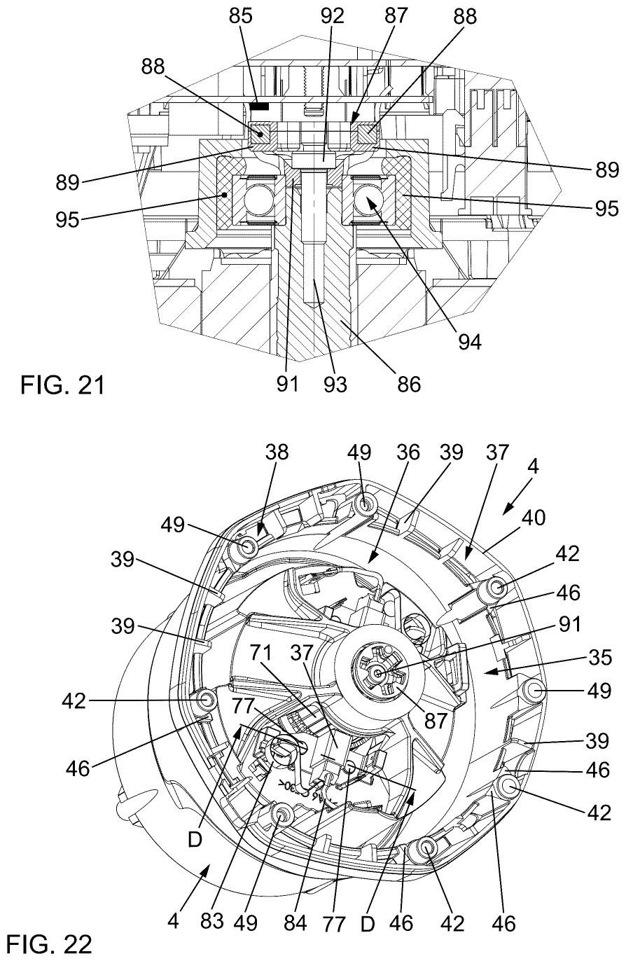

As is further apparent from the combination of FIGS. 18 to 21 and FIGS. 25 and 26, the electronics module 64 additionally comprises, on its underside, a sensor unit 85 that is coupled to the control unit of the electronics module 64 and formed here as a magnetoresistive sensor or Hall sensor. The drive motor 5 further comprises an indicator element coupled to the rotor shaft 86 (see in particular FIG. 21), which is formed here by a magnet ring 87 connected to the free end of the rotor shaft 86. The magnet ring 87 comprises a plurality of magnet elements 88 spaced apart in the circumferential direction, which are formed, for example, by permanent magnets accommodated in pockets 89 of the magnet ring 87.

As is particularly evident from FIGS. 19 and 20, the magnet ring 87 is supported on the free end of the rotor shaft 86 by means of a plurality of holding arms 90 spaced apart in the circumferential direction, wherein the holding arms 90, which are preferably at least partially made of an elastic material, are arranged with their ends facing away from the magnet ring 87 on a support disc 91, which is connected to the free end of the rotor shaft 86 by means of a screw connection 92.

As is clearly evident from FIG. 21, the sensor unit 85 is preferably arranged eccentrically with respect to the rotational axis 93 of the magnet ring 87 or, in the present example, the rotor shaft 86. The sensor unit 85 can detect the position of the magnet elements 88 of the magnet ring 87 and transmit a corresponding signal to the control unit, for example for determining the rotational speed and/or torque of the drive motor 5.

As is further evident from FIG. 21, the rotor shaft 86 is rotatably mounted at least on the side facing the magnet ring 87 in a rolling bearing 94, the outer race 95 of which is made of an elastomer material in this exemplary embodiment.

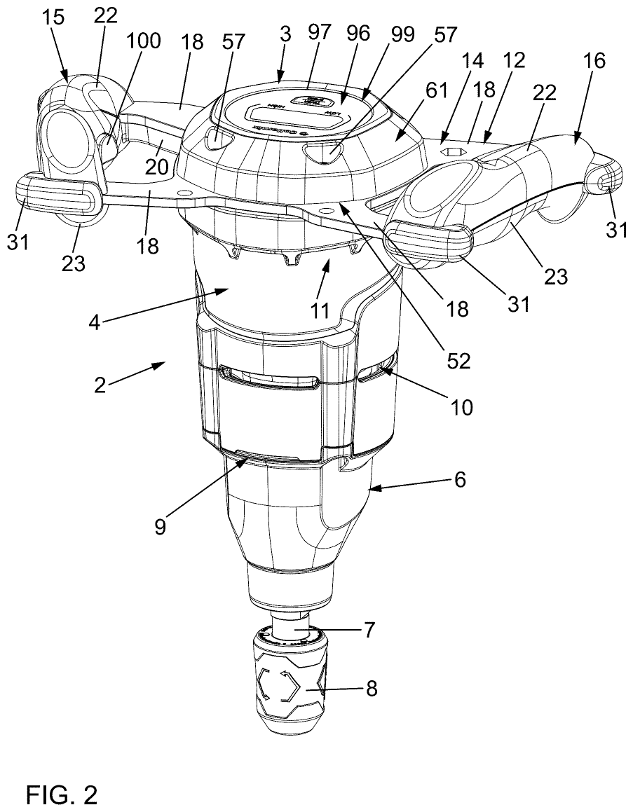

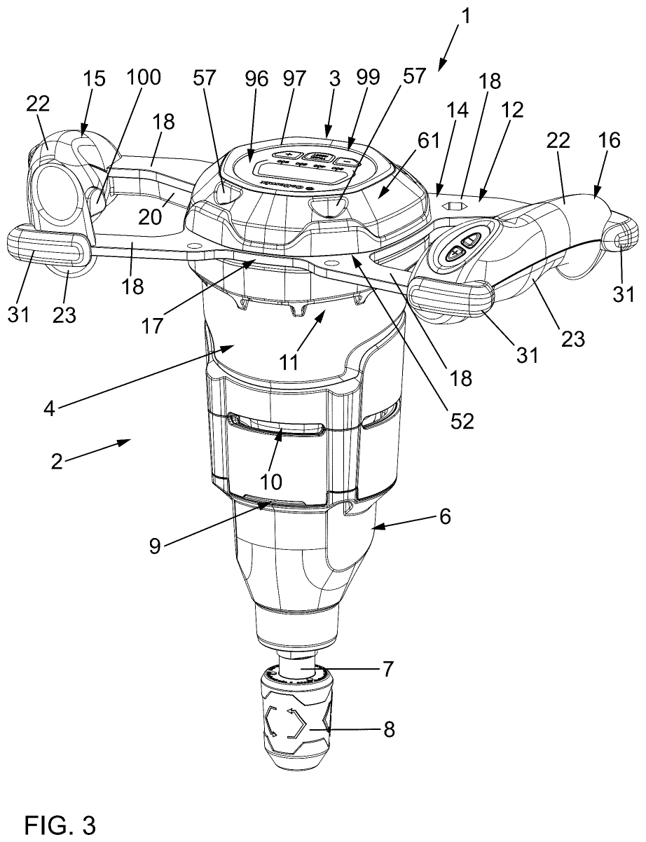

As can be seen particularly from FIGS. 2 and 3 as well as FIGS. 5 and 6, the electronics module 64 has a display and/or operating unit 96 on its top side, by means of which, in the present example, an operating state of the drive motor 5 can be displayed and an operating mode of the drive motor 5 can be input. For this purpose, the display and/or operating unit 96 is freely accessible via an access area formed by an opening 97 in the housing cover 3.

As can be seen from FIGS. 2 and 3 as well as FIGS. 5 and 6, the visible surface 98 of the electronics module 64, which comprises the display and/or operating unit 96, sealingly closes the opening 97 in the mounted state and therefore forms part of the upper side 99 of the housing cover 3.

As is apparent from FIGS. 2 and 3 as well as FIGS. 5 and 6, FIG. 5 shows the top view of the embodiment according to FIG. 3, and FIG. 6 shows the top view of the embodiment according to FIG. 2. Common to the embodiments shown in FIGS. 2 and 3 is that the electronics module 64, which comprises the control unit, is arranged within the interior 35 of the housing in the region of the housing cover 3 and thus, relative to the use position of the construction mixer 1, above the drive motor 5 and electrically connected to the drive motor 5.

The actuation device 13, which in the present case is exemplarily formed as a hand switch, is coupled via a cable connection to the electronics module 64 and thus to the control unit forming part of the electronics module 64, so that upon actuation of the actuation device 13, the drive motor 5 is electronically controlled by the control unit forming part of the electronics module 64.

As can be seen in particular from FIG. 4, the actuation device 13 may further be coupled to a switching lock element 100, which releasably locks the actuation device 13 and must be pressed in addition to the actuation device 13 in order to enable its activation.

As is evident from the combination of FIGS. 5, 28, 29, and 30, which each show the same display and/or operating unit 96, the display and/or operating unit 96 comprises several input buttons 101, 102, 103 as interaction elements, which are exemplarily formed here as physical push-buttons, and by means of which the rotational speed (input buttons 101 and 102) can be set or predefined. As shown in FIGS. 5, 28, 29, and 30, input button 101 is used to reduce the rotational speed, and input button 102 is used to increase it.

Furthermore, it is apparent from the aforementioned figures that the display and/or operating unit 96 comprises a display 104 on which, in the present case, the set rotational speed is shown as a bar chart 105 and the mixing time is shown as a time display 106.

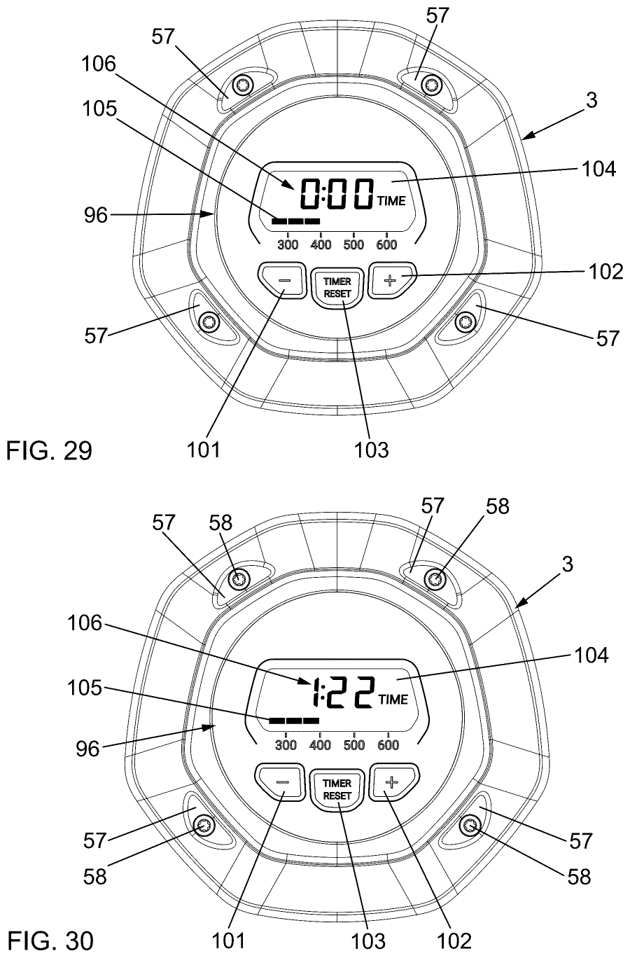

As can be seen from the bar chart 105 in FIGS. 29 and 30, the rotational speed has been set to 400 rpm in this example.

The input button 103, designated as “Timer Reset”, allows the user to reset the time display 106 to zero at the beginning of a mixing process, such that the mixing time is counted upwards from zero upon activation of the construction mixer 1 by means of the actuation device 13 (see FIG. 29). In FIG. 30, for example, the mixing time is displayed as 1 minute and 22 seconds.

In the example shown in FIGS. 5, 28, 29, and 30, the mixing time is displayed purely for information via the time display 106; i.e., no deactivation of the drive motor 5 takes place after a predefined mixing time has elapsed, even though the control unit would generally be capable of being programmed or configured to provide such a function.

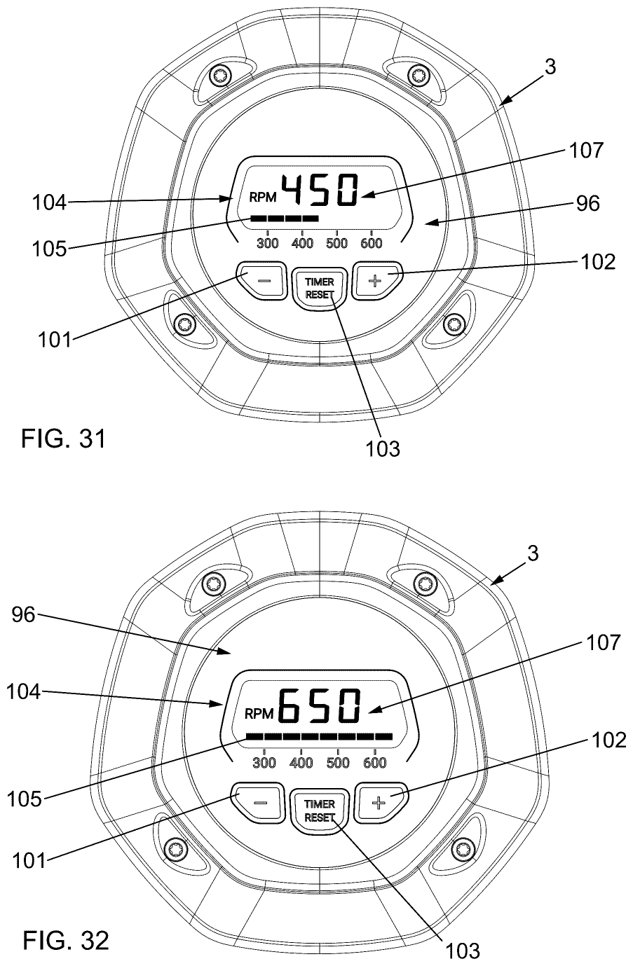

The display and/or operating unit 96 illustrated in FIGS. 31 and 32 corresponds to that shown in FIGS. 29 and 30, with the difference that, in this case, the display 104 now shows the rotational speed as a rotational speed display 107 instead of the mixing time. This can be triggered by the operator, for example, by pressing the input button 103 twice or by pressing the input buttons 101 or 102 to adjust the rotational speed.

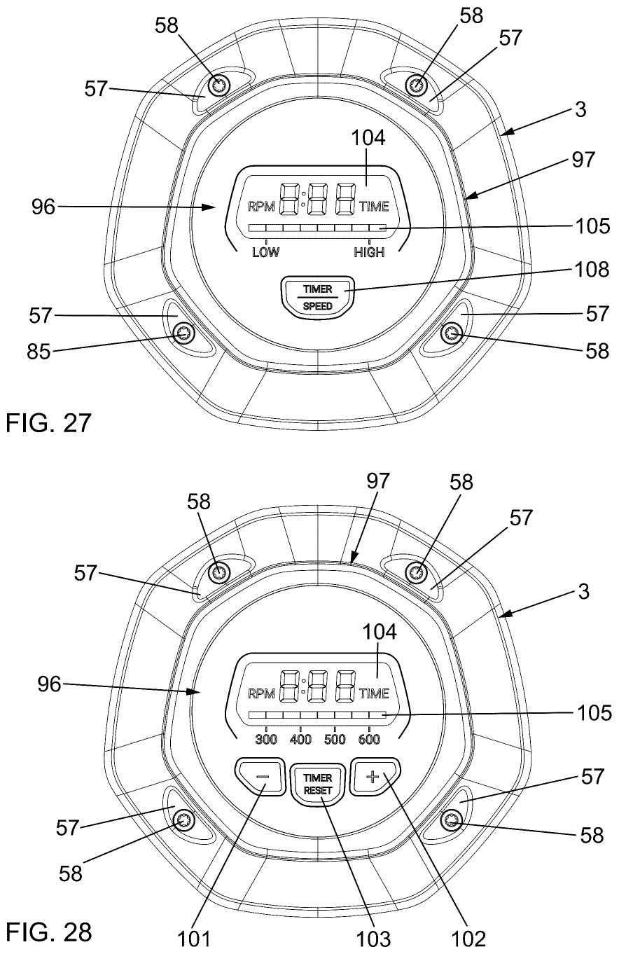

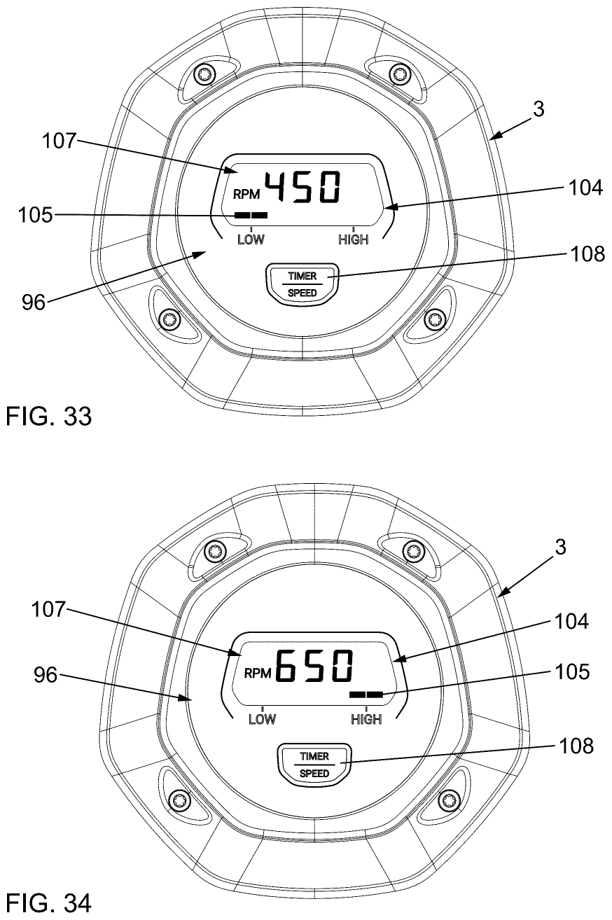

FIG. 27 and FIGS. 33 and 34 show an alternative exemplary embodiment of a display and/or operating unit 96, which corresponds to that shown in FIG. 2, but in which only a single input button 108 is provided as an interaction element. In this embodiment, as can be seen in particular from FIGS. 33 and 34, the display 104 may display a rotational speed display 107 as well as a bar chart 105. The input button 108 may, for instance, be configured with two functions, such that a single press adjusts or toggles the display to show the rotational speed, while a brief press-and-hold resets the time display to zero. The time display itself appears once the drive motor is in operation and/or the actuation device is actuated.

As also evident from FIGS. 5 and 6, the two embodiments according to FIGS. 2 and 3 differ further in that in the embodiment of FIGS. 3 and 5, two input buttons 109, 110 are arranged on an upper side of the handle 16, allowing convenient actuation of both buttons by an operator's thumb.

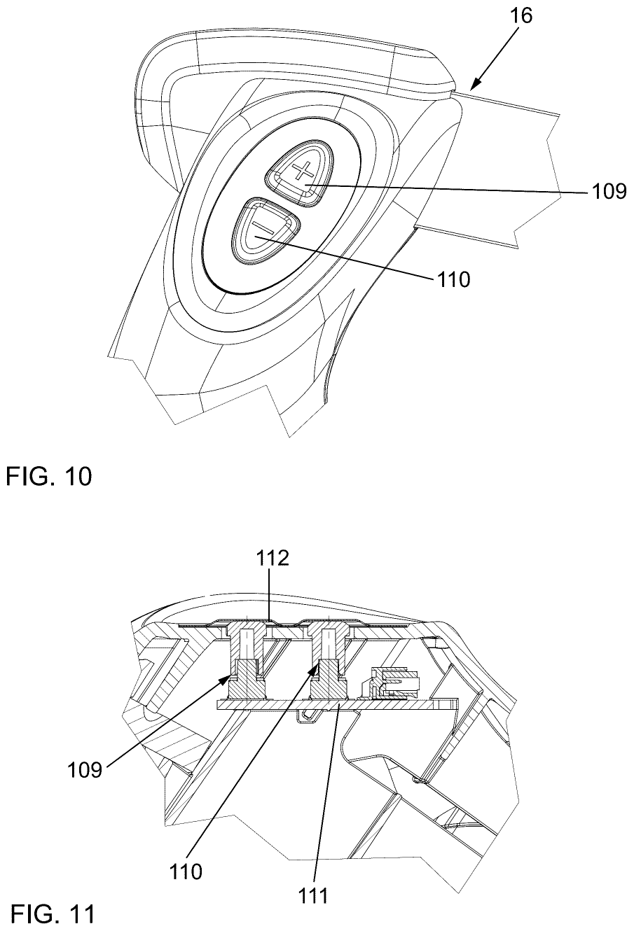

As can be seen in FIGS. 10 and 11, a first input button 109 serves, for example, to increase the rotational speed, while the second input button 110 serves to decrease the speed. The two input buttons 109, 110 are, as shown exemplarily in FIG. 11, which provides a cross-section through the handle area of FIG. 10, formed as push rods covered at their upper side by a key membrane 112, such that the input buttons 109, 110 are operable through said key membrane 112.

The two input buttons 109, 110 are mounted on a printed circuit board 111, which also carries a plug connector 113. This connector is connected, analogously to the actuation device 13, via an unshown cable connection, through the handle 16 and via one of the crossbars 18 of the crossbar grip 14, shielded externally by a crossbar-mounted protective shell, to the housing 2 and further to the electronics module 64.

A particularly preferred configuration is one in which all electrical lines from the drive motor 5, the actuation device 13, and the input buttons 109, 110 are bundled into a single cable harness and, as shown schematically in FIG. 26, equipped with a plug connector 69 that is electrically connected to the plug socket 68 of the electronics module 64.

Thus, the two embodiments of FIGS. 2 and 3 each comprise an electronics module 64 located in the region of the housing cover 3. This is not the case in the simplified embodiment of the construction mixer shown schematically in FIG. 1. In this case, the connection and/or insulation ring 34 is not equipped with an electronics module 64, and the housing cover 3 has no opening 97. Instead, the housing cover 3 is provided with a continuous upper surface 114. The control unit is preferably, though not necessarily, integrated into handle 15 and coupled to the actuation device 13 such that the rotational speed of the construction mixer 1 is adjustable as a function of the actuation travel of the actuation device 13, e.g., when pressed by the operator. Apart from this, the design of the embodiment according to FIG. 1 is identical to that of the embodiments previously described with reference to FIGS. 2 and 3.

The invention has been described herein solely by way of example in conjunction with the figures. Modifications and developments that are within the knowledge of the skilled person are, of course, also encompassed by the scope of the present invention. This applies in particular, for example, to configurations of the construction mixer according to the invention with multiple connection points for mixing and/or stirring tools, such as stirrers, so that, for instance, several such stirrers can be driven in the same or opposite directions.

The following is a summary list of reference numerals and the corresponding structure used in the above description of the invention:
1 construction mixer
2 housing
3 housing cover
4 lower housing part
drive motor
6 transmission
7 drive shaft
8 connection element
9 air slot
air slot
11 air slot
12 handle assembly
13 actuation device/hand switch
14 crossbar
15 handle
16 handle
17 ring element
18 transverse strut
19 hollow and/or receiving space
20 protective shell
21 power cord
22 upper grip shell
23 lower grip shell
24 position hole
25 position hole
26 screw dome
27 through-opening
28 fastening screw
29 recess
30 screw head
31 buffer element
32 locking element
33 locking counter-element
34 connection and/or insulation ring
34 a ring segment
35 housing interior
36 housing opening
37 opening edge region
38 support and receiving surface
39 rib
40 circumferential edge
41 upper surface
42 screw dome
43 through-opening
44 through-opening
45 end face section
46 support region
47 fastening screw
48 upper side
49 centering pin
50 centering opening
51 centering opening
52 circumferential edge section
53 centering pin
54 planar contact surface region
55 screw connection
56 screw-in element
57 through-opening
58 fastening screw
59 screw head
60 dome recess
61 lateral wall section
62 retaining element
63 relief cut
64 electronics module
65 retaining pin
66 spacer
66a spacer wall
67 electrical line
68 plug connector
69 plug
70 snap connection
71 rotor
72 carbon brush
73 carbon brush holder
74 mounting surface
75 support rib
76 base plate
77 centering pin
78 centering recess
79 latch connection
80 hook-in element
81 snap-in element
82 hook-in element
83 spring element
84 electrical line
85 sensor unit
86 rotor shaft
87 magnet ring
88 magnetic element
89 pocket
90 holding arm
91 support disc
92 screw connection
93 axis of rotation
94 rolling bearing
95 outer race
96 display and/or operating unit
97 opening
98 visible surface
99 upper side
100 switching lock element
101 input button
102 input button
103 input button
104 display
105 bar chart
106 time display
107 speed display
108 input button
109 input button
110 input button
111 circuit board
112 key membrane
113 connector plug
114 continuous upper surface
115 fan wheel
116 external gearing
117 stator
118 rotor-stator air gap
119 cooling air
120 air flow channel
121 deflection section
122 air stream
123 sound-damping element
124 Z-shaped flow section
125 spur gear
126 transmission shaft
127 transmission
128 output gearing
129 spur gear
130 connection element

1. A hand-operated construction mixer, comprising:
a housing formed with a housing interior;
a drive motor accommodated, at least in part, in said housing interior, said drive motor having at least one drive shaft to be directly or indirectly operatively connected to a mixing and/or stirring tool;
an actuating device configured for actuating said drive motor;
said drive motor, under control via a control device coupled to said actuating device, being configured to rotate said drive shaft and the mixing and/or stirring tool at a rotational speed in a range from 200 rpm to 1000 rpm.

2. The hand-operated construction mixer according to claim 1, wherein said drive motor is configured to rotate said drive shaft at the rotational speed in a range from 250 rpm to 750 rpm.

3. The hand-operated construction mixer according to claim 2, wherein said drive motor is configured to rotate said drive shaft at the rotational speed in a range from 300 rpm to 650 rpm.

4. The construction mixer according to claim 1, which comprises a gearbox or gear reduction for reducing a motor rotational speed of said drive motor to the rotational speed of said drive shaft, said drive motor having a motor output shaft, being a rotor shaft, configured to rotate at a motor rotational speed in a range selected from 12,000 rpm to 21,000 rpm, from 14,000 rpm to 19,000 rpm, and from 16,000 rpm to 17,000 rpm.

5. The construction mixer according to claim 4, wherein said gearbox is not a gearbox configured for external and/or manual switching by an operator.

6. The construction mixer according to claim 4, wherein said gearbox has a gear reduction ratio in a range from 35:1 to 15:1.

7. The construction mixer according to claim 1, wherein said drive motor is an electric motor comprising a rotor and a stator.

8. The construction mixer according to claim 1, wherein said housing is formed of a plurality of parts comprising, with reference to a usage position of the construction mixer, an upper housing part, which forms a housing cover and is connected to a one-part or multi-part lower housing part.

9. The construction mixer according to claim 1, wherein said actuating device is coupled to said control device, and said control device, upon actuation of said actuating device, electrically controls said drive motor.

10. The construction mixer according to claim 9, wherein said control device is a component of an electronics module, which is arranged in said housing interior above said drive motor, with reference to the usage position of the construction mixer, and is electrically connected to said drive motor.

11. The construction mixer according to claim 1, wherein said housing carries a display and/or operating unit configured for displaying an operating state and/or for entering an operating mode.

12. The construction mixer according to claim 11, wherein said display and/or operating unit is operable and/or accessible via an access area of the housing cover.

13. The construction mixer according to claim 11, wherein an access area to said display and/or operating unit is covered by an operating film or a recess in an upper side of a housing cover of said housing, with said display and/or operating unit being operable and/or accessible through said operating film.

14. The construction mixer according to claim 11, wherein a housing cover of said housing is formed with a recess, and said display and/or operating unit, wherein forms a component of an electronics module, is arranged in said housing interior above said drive motor, is arranged on a visible side of said electronics module, and closes the recess in a mounted state thereof, and forms part of an upper side of said housing cover.

15. The construction mixer according to claim 11, wherein said display and/or operating unit comprises at least one interaction element, being at least one of a physical input button or at least one virtual input surface, or is signal-transmissively connectable to at least one external interaction element, wherein by way of said at least one interaction element at least one mixing parameter, being at least one of a mixing time or a the rotational speed, is adjustable or specifiable, and/or wherein said display and/or operating unit comprises at least one display that is configured to display at least one piece of information characterizing a mixing process, including at least one of the mixing time or the rotational speed.

16. The construction mixer according to claim 15, wherein said control device comprises a time counter function, including a pause function, by way of which the mixing time is displayable on said at least one display upon actuation of the actuating device, wherein a time counter is started for a predetermined time upon actuation of the construction mixer by way of the actuating device, and/or wherein the time counter has a pause function, by way of which, depending on a predetermined pause time, the time counter is either reset to zero when the pause time is exceeded or continues to run when the pause time is not exceeded.

17. The construction mixer according to claim 1, which comprises a handle unit forming at least one handle that is connected to said housing.

18. The construction mixer according to claim 17, wherein said actuating device includes a hand switch forming a part of said handle unit and being connectable to said control device of an electronics module, and said actuating device is coupled to a power-on locking element, which releasably locks the actuating device and is activatable in addition to said actuating device for releasing its actuation.

19. The construction mixer according to claim 1, wherein the construction mixer is configured as a hand-operated stirring machine for at least one of stirring or mixing construction materials.

20. A method for operating a hand-held construction mixer, which has a housing and a drive motor at least partially accommodated in a housing interior of the housing, wherein the drive motor has at least one drive shaft, which is directly or indirectly operatively connectable to a mixing and/or stirring tool, and wherein the drive motor is actuatable via an actuating device, the method comprising:
controlling the drive motor by way of a control device coupled to the actuating device; and
operating the motor for rotatably driving a drive shaft carrying at least one of a mixing or stirring tool at a rotational speed, being a load rotational speed, in a range from 200 rpm to 1000 rpm.
